(19) United States
(12) Patent Application Publication
(10) Pub. No.: US 2025/0257295 A1
(43) Pub. Date: Aug. 14, 2025

(54) SOLID ARTICLES WITH REDUCED RESIDUE

(71) Applicant: The Procter & Gamble Company, Cincinnati, OH (US)

(72) Inventors: Lindsey HEATHCOTE, Northumberland (GB); Mark Robert Sivik, Mason, OH (US); Philip Frank SOUTER, Morpeth Northumberland (GB); Michelle Jackson, Newcastle Upon Tyne (GB)

(21) Appl. No.: 19/051,232

(22) Filed: Feb. 12, 2025

Related U.S. Application Data
(60) Provisional application No. 63/552,824, filed on Feb. 13, 2024.
(60) Provisional application No. 63/566,944, filed on Mar. 19, 2024.

(51) Int. Cl. C11D 17/04; C11D 1/22; C11D 1/29; C11D 1/37

(52) U.S. Cl. CPC C11D 17/044; C11D 1/37; C11D 1/22; C11D 1/29

(57) ABSTRACT

A dissolvable solid article includes a porous, dissolvable sheet and a particulate material. The particulate material includes one or more at least partially water insoluble particles including a first component and a second component. The second component has a dry particle size of from about 0.01 μm to about 20 μm.

### TECHNICAL FIELD

The present disclosure relates generally to laundry detergents and solid articles and more specifically to laundry detergents and solid articles exhibiting reduced residue deposition on fabrics.

### BACKGROUND

Some detergent formulations, while effective in removing stains, may introduce undesirable residue buildup on laundered items, compromising appearance, fabric softness, and user comfort. This issue has become increasingly pronounced as consumer expectations evolve to demand not only superior cleaning efficacy but also a residue-free post-wash look and feel. The challenge lies in developing detergent compositions and convenient forms for delivering those detergent compositions that excel in stain removal while mitigating the tendency to leave behind unwanted residues on fabrics. Addressing this concern is crucial in meeting the growing preference for environmentally friendly and fabric-safe laundry solutions, aligning with the evolving standards of modern consumers.

The discussion of shortcomings and needs existing in the field prior to the present disclosure is in no way an admission that such shortcomings and needs were recognized by those skilled in the art prior to the present disclosure.

### SUMMARY

Various iterations solve the above-mentioned problems and provide compositions, articles, and methods useful for providing detergent compositions and convenient forms for delivering those detergent compositions that excel in stain removal while mitigating the tendency to leave behind unwanted residues on fabrics.

Various embodiments relate to a laundry detergent composition comprising a particulate material. The particulate material may comprise one or more at least partially water insoluble particles. The at least one particle may comprise a first component, preferably an active component, and a second component, preferably a non-active component. The second component, preferably a non-active component, is at least partially water insoluble and may have a dry particle size of from about 0.01 μm to about 20 μm. Various embodiments relate to a solid article comprising a porous dissolvable sheet and the laundry detergent composition or at least the particulate material.

Various iterations relate to a solid article comprising a water-soluble flexible, porous structure. A solid article may have one or a plurality of layers. A plurality of particles may be dispersed within a layer, dispersed between a plurality of layers, or a combination thereof. One, more than one, or each of the plurality of particles may comprise a first component, preferably an active component, and second component, preferably a non-active component. Upon exposure to water at a temperature of 5° C. to 40° C., preferably about 10° C. to about 25° C. for a time of about 5 minutes to about 60 minutes, preferably about 10 minutes to about 20 minutes, at least about 50% to about 100%, preferably about 70% to 90% of the plurality of particles may release at least some of the first component, preferably an active component, contained therein, and have a particle size of from about 0.01 μm to about 50 μm.

These and other features, aspects, and advantages of various iterations will become better understood with reference to the following description, figures, and claims.

### BRIEF DESCRIPTION OF THE DRAWINGS

Many aspects of this disclosure can be better understood with reference to the following figures, which illustrate examples according to various embodiments.

FIG. 1A is a schematic view of an exemplary flexible, porous, dissolvable solid sheet article according to the present disclosure.

FIG. 1B is a cross-section view of the solid sheet article of FIG. 1A along lines A-A.

FIG. 2 is a perspective view of an embodiment of a single-dose laundry detergent unit embodying a new design.

FIG. 3 is a schematic top view of a piece of test fabric with a residue deposited thereon.

FIG. 4A is a photograph of an untreated/unstained sample of C70 black fabric.

FIG. 4B is a photograph of a first replicate of a C70 black fabric after exposure to Composition 1 at 10° C.

FIG. 4C is a photograph of a second replicate of a C70 black fabric after exposure to Composition 1 at 10° C.

FIG. 4D is a photograph of a third replicate of a C70 black fabric after exposure to Composition 2 at 10° C.

FIG. 5A is a photograph of an untreated/unstained sample of C70 black fabric.

FIG. 5B is a photograph of a first replicate of a C70 black fabric after exposure to Composition 2 at 10° C.

FIG. 5C is a photograph of a second replicate of a C70 black fabric after exposure to Composition 2 at 10° C.

FIG. 5D is a photograph of a third replicate of a C70 black fabric after exposure to Composition 2 at 10° C.

FIG. 6A is a photograph of an untreated/unstained sample of C70 black fabric.

FIG. 6B is a photograph of a first replicate of a C70 black fabric after exposure to Composition 3 at 10° C.

FIG. 6C is a photograph of a second replicate of a C70 black fabric after exposure to Composition 3 at 10° C.

FIG. 6D is a photograph of a third replicate of a C70 black fabric after exposure to Composition 3 at 10° C.

FIG. 7A is a photograph of an untreated/unstained sample of C70 black fabric.

FIG. 7B is a photograph of a first replicate of a C70 black fabric after exposure to Composition 4 at 10° C.

FIG. 7C is a photograph of a second replicate of a C70 black fabric after exposure to Composition 4 at 10° C.

FIG. 7D is a photograph of a third replicate of a C70 black fabric after exposure to Composition 4 at 10° C.

FIG. 8A is a photograph of an untreated/unstained sample of C70 black fabric.

FIG. 8B is a photograph of a first replicate of a C70 black fabric after exposure to Composition 1 at 25° C.

FIG. 8C is a photograph of a second replicate of a C70 black fabric after exposure to Composition 1 at 25° C.

FIG. 8D is a photograph of a third replicate of a C70 black fabric after exposure to Composition 1 at 25° C.

FIG. 9A is a photograph of an untreated/unstained sample of C70 black fabric.

FIG. 9B is a photograph of a first replicate of a C70 black fabric after exposure to Composition 2 at 25° C.

FIG. 9C is a photograph of a second replicate of a C70 black fabric after exposure to Composition 2 at 25° C.

FIG. 9D is a photograph of a third replicate of a C70 black fabric after exposure to Composition 2 at 25° C.

FIG. 10A is a photograph of an untreated/unstained sample of C70 black fabric.

FIG. 10B is a photograph of a first replicate of a C70 black fabric after exposure to Composition 3 at 25° C.

FIG. 10C is a photograph of a second replicate of a C70 black fabric after exposure to Composition 3 at 25° C.

FIG. 10D is a photograph of a third replicate of a C70 black fabric after exposure to Composition 3 at 25° C.

FIG. 11A is a photograph of an untreated/unstained sample of C70 black fabric.

FIG. 11B is a photograph of a first replicate of a C70 black fabric after exposure to Composition 4 at 25° C.

FIG. 11C is a photograph of a second replicate of a C70 black fabric after exposure to Composition 4 at 25° C.

FIG. 11D is a photograph of a third replicate of a C70 black fabric after exposure to Composition 4 at 25° C.

FIG. 12A is a photograph of a first replicate, a second replicate, and a third replicate of a technical black cotton fabric after exposure to a zeolite having a dry particle size of 4 μm.

FIG. 12B is a photograph of a first replicate, a second replicate, and a third replicate of a technical black cotton fabric after exposure to precipitated calcium carbonate having a dry particle size of 7 μm.

FIG. 12C is a photograph of a first replicate, a second replicate, and a third replicate of a technical black cotton fabric after exposure to a magnesium carbonate (MgCO₃) having a dry particle size of 15 μm.

FIG. 12D is a photograph of a first replicate, a second replicate, and a third replicate of a technical black cotton fabric after exposure to microcrystalline cellulose having a dry particle size of 20 μm.

FIG. 12E is a photograph of a first replicate, a second replicate, and a third replicate of a technical black cotton fabric after exposure to a microcrystalline cellulose having a dry particle size of 50 μm.

FIG. 13A is a photograph of a first replicate, a second replicate, and a third replicate of a consumer black polyester fabric after exposure to a zeolite having a dry particle size of 4 μm.

FIG. 13B is a photograph of a first replicate, a second replicate, and a third replicate of a consumer black polyester fabric after exposure to precipitated calcium carbonate having a dry particle size of 7 μm.

FIG. 13C is a photograph of a first replicate, a second replicate, and a third replicate of a consumer black polyester fabric after exposure to a magnesium carbonate (MgCO₃) having a dry particle size of 15 μm.

FIG. 13D is a photograph of a first replicate, a second replicate, and a third replicate of a consumer black polyester fabric after exposure to microcrystalline cellulose having a dry particle size of 20 μm.

FIG. 13E is a photograph of a first replicate, a second replicate, and a third replicate of a consumer black polyester fabric after exposure to a microcrystalline cellulose having a dry particle size of 50 μm.

FIG. 14 is a photograph showing the radius of inspection for the results shown in Tables 7 and 8.

FIGS. 15A-15D are photographs, wherein each FIG. shows a first replicate, second replicate, and a third replicate of a consumer black cotton fabric exposed to Compositions 1 through 4 at a temperature of 10 degrees C.

FIGS. 16A-16D are photographs, wherein each FIG. shows a first replicate, second replicate, and a third replicate of a consumer black cotton fabric exposed to Compositions 1 through 4 at a temperature of 25 degrees C.

It should be understood that the various embodiments are not limited to the examples illustrated in the figures.

### DETAILED DESCRIPTION

### I. Definitions

This disclosure is written to describe the invention to a person having ordinary skill in the art, who will understand that this disclosure is not limited to the specific examples or embodiments described. The examples and embodiments are single instances of the invention which will make a much larger scope apparent to the person having ordinary skill in the art. Unless defined otherwise, all technical and scientific terms used herein have the same meaning as commonly understood by the person having ordinary skill in the art. It is also to be understood that the terminology used herein is for the purpose of describing examples and embodiments only, and is not intended to be limiting, since the scope of the present disclosure will be limited only by the appended claims.

All the features disclosed in this specification (including any accompanying claims, abstract, and drawings) may be replaced by alternative features serving the same, equivalent, or similar purpose, unless expressly stated otherwise. Thus, unless expressly stated otherwise, each feature disclosed is one example only of a generic series of equivalent or similar features. The examples and embodiments described herein are for illustrative purposes only and that various modifications or changes in light thereof will be suggested to the person having ordinary skill in the art and are to be included within the spirit and purview of this application. Many variations and modifications may be made to the embodiments of the disclosure without departing substantially from the spirit and principles of the disclosure. All such modifications and variations are intended to be included herein within the scope of this disclosure. For example, unless otherwise indicated, the present disclosure is not limited to particular materials, reagents, reaction materials, manufacturing processes, or the like, as such can vary. It is also to be understood that the terminology used herein is for purposes of describing particular embodiments only and is not intended to be limiting. It is also possible in the present disclosure that steps can be executed in different sequence where this is logically possible.

All numeric values are herein assumed to be modified by the term “about,” whether or not explicitly indicated. The term “about” generally refers to a range of numbers that one of skill in the art would consider equivalent to the recited value (for example, having the same function or result). In many instances, the term “about” may include numbers that are rounded to the nearest significant figure.

In everyday usage, indefinite articles (like “a” or “an”) precede countable nouns and noncountable nouns almost never take indefinite articles. It must be noted, therefore, that, as used in this specification and in the claims that follow, the singular forms “a,” “an,” and “the” include plural referents unless the context clearly dictates otherwise. Thus, for example, reference to “a support” includes a plurality of supports. Particularly when a single countable noun is listed as an element in a claim, this specification will generally use a phrase such as “a single.” For example, “a single support.”

Unless otherwise specified, all percentages indicating the amount of a component in a composition represent a percent by weight of the component based on the total weight of the composition.

Where a range of values is provided, it is understood that each intervening value, to the tenth of the unit of the lower limit (unless the context clearly dictates otherwise), between the upper and lower limit of that range, and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

In this specification and in the claims that follow, reference will be made to a number of terms that shall be defined to have the following meanings unless a contrary intention is apparent.

“Active Component” is the specific component(s) or chemical substance(s) within a formulation or product that is/are responsible for producing an intended functional effect.

Non-Active Component” refers to other components or substances present in a formulation or product that do not constitute the primary active component responsible for producing the intended functional effect.

“Particle size” may refer to the size of a single particle or to the size of a plurality of particles, such as, for example, a cluster of particles. The particle size of a spherical object can be unambiguously and quantitatively defined by its diameter. However, a typical material object is likely to be irregular in shape and non-spherical. There are several ways of extending the term “particle size” to apply to non-spherical particles. Existing definitions are based on replacing a given particle or cluster with an imaginary sphere that has one of the properties identical with the particle. Volume-based particle size equals the diameter of the sphere that has the same volume as a given particle. Area-based particle size equals the diameter of the sphere that has the same surface area as a given particle or cluster. Weight-based particle size equals the diameter of the sphere that has the same weight as a given particle or cluster. Hydrodynamic or aerodynamic particle size equals the diameter of the sphere that has the same drag coefficient as a given particle or cluster.

Pluralities of particles may have a particle size distribution. D50 and D100 are parameters commonly used in particle size distribution analysis to describe the median and maximum particle sizes, respectively. The D50 represents the particle size at which 50% of the cumulative mass of particles is smaller, while the D100 is the size below which 100% of the cumulative mass of particles is contained. The D50 serves as the midpoint of the particle size distribution, indicating the size in the middle of the distribution when particles are arranged in ascending order. In contrast, the D100 signifies the maximum size of particles in the distribution, where the cumulative distribution curve reaches 100%. The particles described herein may have a particle size distribution such that the D50 is from greater than about 150 micrometers to less than about 1700 micrometers.

“Dry particle size” of a material refers to the size of individual particles, aggregates, or agglomerates of the material when measured under conditions of low environmental relative humidity, specifically at an ambient temperature, where the environmental relative humidity is maintained at a level of less than 15%. This measurement is carried out to prevent or minimize any moisture-induced changes in the size, structure, or properties of the particles, ensuring that the size measurement accurately represents the material's characteristics in a low-humidity environment. The dry particle size may be determined using suitable techniques and instruments, such as laser diffraction, dynamic light scattering, or similar methods appropriate for the material under consideration. The dry particle size measurement provides valuable information for various applications, including but not limited to the pharmaceutical, chemical, and materials industries, where maintaining low humidity conditions is critical to preserve the material's integrity and performance.

“Average dry particle size” of a material is the mean size of individual particles, aggregates, or agglomerates of the material when measured under low environmental relative humidity (less than 15%) at ambient temperature, following the method defined for “dry particle size.” This measurement is crucial for various applications, including pharmaceuticals, chemicals, and materials, where maintaining low humidity conditions is essential for preserving material integrity and performance.

“Water-insoluble” refers to a substance or material that cannot be effectively dissolved or dispersed in water under ordinary conditions. When a material is labeled as “water-insoluble,” it implies that it exhibits limited or negligible solubility in water, and any attempt to dissolve it in water results in only minimal or no appreciable change in its physical state or chemical composition.

“At Least Partially Water-Insoluble” refers to a substance or material that, while not entirely insoluble in water, possesses limited or restricted solubility in water under ordinary conditions. Unlike materials that are completely water-insoluble, those described as “at least partially water-insoluble” may exhibit some degree of solubility or dispersion in water, but the extent of dissolution is minimal, and they generally do not readily dissolve or disperse in water.

“Swelling Index” is a numerical value representing the swelling capacity of a particle. It can be calculated by dividing the volume or weight of a swollen particle after immersion in water at a temperature of T (° C.) for a time t (sec) by the initial volume the dry particle. The swelling index is a dimensionless number.

$$Swelling Index = \frac{Volume of particle after exposure to water at T ( ° C . ) for t ( sec )}{Initial Volume of dry particle}$$

“Swelling index-adjusted particle size” is a quantitative measure that reflects the dimensions of a single particle or the average size of a group of particles when they have reached their maximum swelling capacity. This adjusted particle size is obtained by multiplying the particle size by the swelling index.

A “derivative of cellulose” is a compound or material that is chemically modified from cellulose, a natural polysaccharide found in plant cell walls. Cellulose derivatives may be created by altering the structure of cellulose through various chemical processes to impart specific properties or functionalities, such as improved solubility, increased flexibility, or enhanced compatibility with other materials. These modifications may result in a wide range of cellulose derivatives, and non-limiting examples include cellulose acetate, hydroxyethyl cellulose (HEC), methylcellulose, carboxymethyl cellulose (CMC), cellulose ethers (such as ethylcellulose, hydroxypropyl cellulose, and hydroxypropyl methylcellulose), and nitrocellulose.

“Crystalline Material” is a substance or solid structure characterized by the orderly and repeating arrangement of its constituent atoms, ions, or molecules in a three-dimensional lattice or framework. In a crystalline material, the atoms or particles are positioned with a high degree of periodicity, resulting in the formation of distinct, well-defined crystal structures. These materials exhibit specific and repeatable geometric patterns, known as crystal lattices, which give rise to the material's unique physical and chemical properties, including well-defined melting points, regular cleavage planes, and optical characteristics, such as birefringence. The opposite of a crystalline material is an amorphous material, which lacks a long-range order in its atomic arrangement. Crystalline materials can encompass a wide range of substances, including metals, minerals, and various organic and inorganic compounds.

“Ambient conditions” as used herein means 23° C.±1.0° C. and a relative humidity of 50%±2%. The water-soluble solid article may contain insoluble materials, which are dispersible in aqueous wash conditions to a suspension mean particle size that is less than about 20 microns, or less than about 50 microns.

The term “flexible” as used herein refers to the ability of an article to withstand stress without breakage or significant fracture when it is bent at 90° along a center line perpendicular to its longitudinal direction. Preferably, such article can undergo significant elastic deformation and is characterized by a Young's Modulus of no more than 5 GPa, preferably no more than 1 GPa, more preferably no more than 0.5 GPa, most preferably no more than 0.2 GPa.

The term “solid” as used herein refers to the ability of an article to substantially retain its shape (i.e., without any visible change in its shape) at 20° C. and under the atmospheric pressure, when it is not confined and when no external force is applied thereto.

The term “sheet” as used herein refers to a non-fibrous structure having a three-dimensional shape, i.e., with a thickness, a length, and a width, while the length-to-thickness aspect ratio and the width-to-thickness aspect ratio are both at least about 5:1, and the length-to-width ratio is at least about 1:1. Preferably, the length-to-thickness aspect ratio and the width-to-thickness aspect ratio are both at least about 10:1, more preferably at least about 15:1, most preferably at least about 20:1; and the length-to-width aspect ratio is preferably at least about 1.2:1, more preferably at least about 1.5:1, most preferably at least about 1.618:1.

The term “essentially free of” or “essentially free from” means that the indicated material is at the very minimal not deliberately added to the composition or product, or preferably not present at an analytically detectible level in such composition or product. It may include compositions or products in which the indicated material is present only as an impurity of one or more of the materials deliberately added to such compositions or products.

### Solid Article

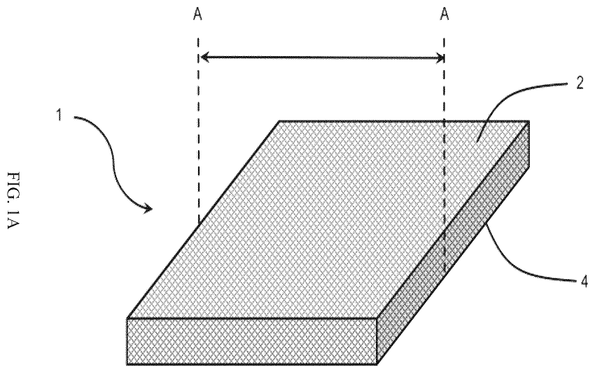

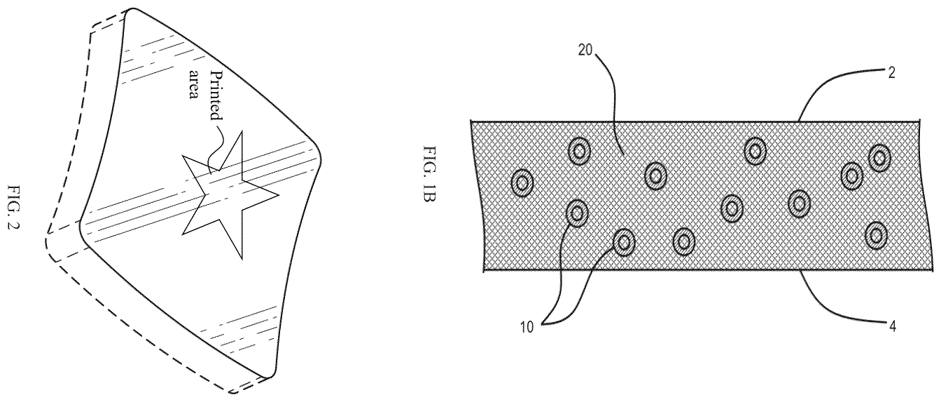

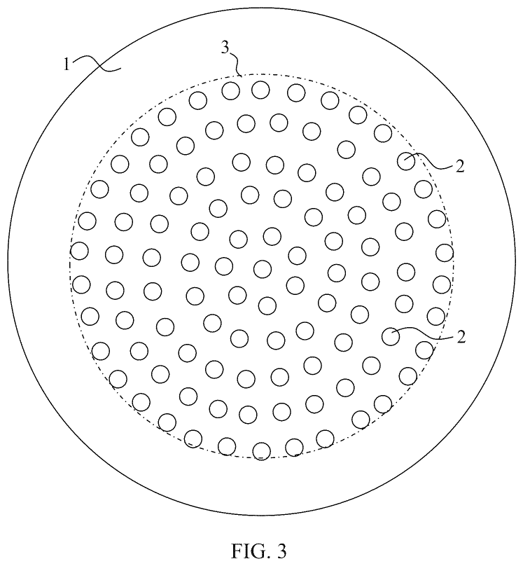

A solid article can be in the form, for example, of a flexible, porous, dissolvable solid sheet. FIGS. 1A and 1B show schematic and cross-section views of an exemplary flexible, porous, dissolvable solid sheet 1, which has opposing first and second planar surfaces 2 and 4. At least one particle 10 is located between said opposing first and second surfaces 2 and 4. This particle can be located in a matrix 20 formed by the water-soluble polymer, the surfactant, and optionally other adjunct ingredients (not shown). Preferably a majority, more preferably more than 80%, still more preferably more than 90%, most preferably more than 90%, of the particles 10 are located between the opposing first and second surfaces 2 and 4.

A flexible, porous, dissolvable solid sheet may be formed by the processing steps described below, or any processing known in the art. The sheet and/or article may have a Young's modulus of no more than 5 GPa, no more than 1 GPa, no more than 0.5 GPa, or no more than 0.2 GPa. The sheet and/or article may completely dissolve in or disperse into water leaving no visible solids or forming no visibly separate phase, when at least about 25 grams, at least about 50 grams, at least about 100 grams, or at least about 200 grams, of such material is placed in one liter (1 L) of deionized water at 20° C. and under the atmospheric pressure with sufficient stirring.

In general, such solid sheet may be characterized by: (i) a Percent Open Cell Content of from about 80% to 100%, from about 85% to 100%, or from about 90% to 100%, as measured by the Test 3 hereinafter; and (ii) an Overall Average Pore Size of from about 100 μm to about 2000 μm, from about 150 μm to about 1000 μm, or from about 200 μm to about 600 μm, as measured by the Micro-CT method described in Test 2 hereinafter. The Overall Average Pore Size defines the porosity of the OCF (open cell foam) structure. The Percent Open Cell Content defines the interconnectivity between pores in the OCF structure. Interconnectivity of the OCF structure may also be described by a Star Volume or a Structure Model Index (SMI) as disclosed in WO2010077627 and WO2012138820.

Such solid sheet has opposing top and bottom surfaces, while its top surface may be characterized by a Surface Average Pore Diameter that is greater than about 100 μm, greater than about 110 μm, greater than about 120 μm, greater than about 130 μm, or greater than about 150 μm, as measured by the SEM method described in Test 1 hereinafter. When comparing with solid sheets formed by conventional heating/drying arrangements (e.g., the convection-based, the microwave-based, or the impingement oven-based arrangements), the solid sheet formed by the improved heating/drying arrangement has a significantly larger Surface Average Pore Diameter at its top surface, because under the specifically arranged directional heating, the top surface of the formed sheet of aerated wet pre-mixture is the last to dry/solidify, and the air bubbles near the top surface has the longest time to expand and form larger pore openings at the top surface. The solid sheet may be further characterized by an Average Cell Wall Thickness of from about 5 μm to about 200 μm, from about 10 μm to about 100 μm, or from about 10 μm to about 80 μm, as measured by Test 2 hereinafter.

The solid sheet may contain a small amount of water. It may be characterized by a final moisture content of from 0.5% to 25%, from 1% to 20%, or from 3% to 10%, by weight of the solid sheet, as measured by Test 4 hereinafter. An appropriate final moisture content in the resulting solid sheet may ensure the desired flexibility/deformability of the sheet, as well as providing soft/smooth sensory feel to the consumers. If the final moisture content is too low, the sheet may be too brittle or rigid. If the final moisture content is too high, the sheet may be too sticky, and its overall structural integrity may be compromised.

The solid sheet may have a thickness ranging from about 0.6 mm to about 3.5 mm, from about 0.7 mm to about 3 mm, from about 0.8 mm to about 2 mm, or from about 1 mm to about 2 mm. Thickness of the solid sheet can be measured using Test 6 described hereinafter. The solid sheet after drying may be slightly thicker than the sheet of aerated wet pre-mixture, due to pore expansion that in turn leads to overall volume expansion.

The solid sheet may further be characterized by a basis weight of from about 50 grams/m² to about 500 grams/m², from about 150 grams/m² to about 450 grams/m², or from about 250 grams/m² to about 400 grams/m², as measured by Test 6 described hereinafter.

Still further, the solid sheet may have a density ranging from about 0.05 grams/cm³ to about 0.5 grams/cm³, from about 0.06 grams/cm³ to about 0.4 grams/cm³, from about 0.07 grams/cm³ to about 0.2 grams/cm³, or from about 0.08 grams/cm³ to about 0.15 grams/cm³, as measured by Test 7 hereinafter. Density of the solid sheet is lower than that of the sheet of aerated wet pre-mixture, also due to pore expansion that in turn leads to overall volume expansion.

In some examples, the solid sheets may have a density of from about 0.06 grams/cm³ to about 0.16 grams/cm³, from about 0.07 grams/cm³ to about 0.15 grams/cm³, or from about 0.08 grams/cm³ to about 0.145 grams/cm³. The solid article containing sheets with such relatively low density may achieve even more improved leakage performance.

Furthermore, the solid sheet can be characterized by a Specific Surface Area of from about 0.03 m²/g to about 0.25 m²/g, from about 0.04 m²/g to about 0.22 m²/g, from 0.05 m²/g to 0.2 m²/g, from 0.1 m²/g to 0.18 m²/g, as measured by Test 8 described hereinafter. The Specific Surface Area of the solid sheet may be indicative of its porosity and may impact its dissolution rate, e.g., the greater the Specific Surface Area, the more porous the sheet and the faster its dissolution rate.

The solid sheet and/or the dissolvable solid article may be characterized by:
a Percent Open Cell Content of from 85% to 100%, from 90% to 100%; and/or
an Overall Average Pore Size of from 150 μm to 1000 μm, from 200 μm to 600 μm; and/or
an Average Cell Wall Thickness of from 5 μm to 200 μm, from 10 μm to 100 μm, from 10 μm to 80 μm; and/or
a final moisture content of from 0.5% to 25%, from 1% to 20%, from 3% to 10%, by weight of the solid sheet article; and/or
a thickness of from 0.6 mm to 3.5 mm, from 0.7 mm to 3 mm, from 0.8 mm to 2 mm, from 1 mm to 2 mm; and/or
a basis weight of from about 50 grams/m² to about 500 grams/m², from about 150 grams/m² to about 450 grams/m², from about 250 grams/m² to about 400 grams/m²; and/or
a density of from 0.05 grams/cm³ to 0.5 grams/cm³, from 0.06 grams/cm³ to 0.4 grams/cm³, from 0.07 grams/cm³ to 0.2 grams/cm³, from 0.08 grams/cm³ to 0.15 grams/cm³; and/or
a Specific Surface Area of from 0.03 m²/g to 0.25 m²/g, from 0.04 m²/g to 0.22 m²/g, from 0.05 m²/g to 0.2 m²/g, from 0.1 m²/g to 0.18 m²/g.

### Formulation of Solid Article

### Water Soluble Polymer

As mentioned hereinabove, the flexible, porous, dissolvable solid sheet may be formed by a wet pre-mixture that comprises a water-soluble polymer and a first surfactant. Such a water-soluble polymer may function in the resulting solid sheet as a film-former, a structurant as well as a carrier for other active ingredients (e.g., surfactants, emulsifiers, builders, chelants, perfumes, colorants, and the like).

The wet pre-mixture may comprise from about 3% to about 20% by weight of the pre-mixture of water-soluble polymer, in one example from about 5% to about 15% by weight of the pre-mixture of water-soluble polymer, in one example from about 7% to about 10% by weight of the pre-mixture of water-soluble polymer.

After drying, it the water-soluble polymer may be present in the flexible, porous, dissolvable solid sheet in an amount ranging from about 5% to about 60%, from about 7% to about 50%, from about 9% to about 40%, from about 10% to about 30%, for example 10%, 12%, 15%, 18%, 20%, 25%, 30% or any ranges therebetween, by total weight of the solid sheet. The total amount of water-soluble polymer(s) present in the flexible, porous, dissolvable solid sheet may be no more than 25% by total weight of such sheet.

Water-soluble polymers suitable for use herein may be selected those with weight average molecular weights ranging from about 5,000 to about 400,000 Daltons, from about 10,000 to about 300,000 Daltons, from about 15,000 to about 200,000 Daltons, from about 20,000 to about 150,000 Daltons. The weight average molecular weight is computed by summing the average molecular weights of each polymer raw material multiplied by their respective relative weight percentages by weight of the total weight of polymers present within the porous solid sheet. The weight average molecular weight of the water-soluble polymer used herein may impact the viscosity of the wet pre-mixture, which may in turn influence the bubble number and size during the aeration step as well as the pore expansion/opening results during the drying step. Further, the weight average molecular weight of the water-soluble polymer may affect the overall film-forming properties of the wet pre-mixture and its compatibility/incompatibility with certain surfactants.

The water-soluble polymers may include, but are not limited to, synthetic polymers including polyvinyl alcohols, polyvinylpyrrolidones, polyalkylene oxides, polyacrylates, caprolactams, polymethacrylates, polymethylmethacrylates, polyacrylamides, polymethylacrylamides, polydimethylacrylamides, polyethylene glycol monomethacrylates, copolymers of acrylic acid and methyl acrylate, polyurethanes, polycarboxylic acids, polyvinyl acetates, polyesters, polyamides, polyamines, polyethyleneimines, maleic/(acrylate or methacrylate) copolymers, copolymers of methylvinyl ether and of maleic anhydride, copolymers of vinyl acetate and crotonic acid, copolymers of vinylpyrrolidone and of vinyl acetate, copolymers of vinylpyrrolidone and of caprolactam, vinyl pyrollidone/vinyl acetate copolymers, copolymers of anionic, cationic and amphoteric monomers, and combinations thereof.

The water-soluble polymers may also be selected from naturally sourced polymers including those of plant origin examples of which include karaya gum, tragacanth gum, gum Arabic, acemannan, konjac mannan, acacia gum, gum ghatti, whey protein isolate, and soy protein isolate; seed extracts including guar gum, locust bean gum, quince seed, and psyllium seed; seaweed extracts such as Carrageenan, alginates, and agar; fruit extracts (pectins); those of microbial origin including xanthan gum, gellan gum, pullulan, hyaluronic acid, chondroitin sulfate, and dextran; and those of animal origin including casein, gelatin, keratin, keratin hydrolysates, sulfonic keratins, albumin, collagen, glutelin, glucagons, gluten, zein, and shellac.

Modified natural polymers can also be used as water-soluble polymers herein. Suitable modified natural polymers include, but are not limited to, cellulose derivatives such as hydroxypropylmethylcellulose, hydroxymethylcellulose, hydroxyethylcellulose, methylcellulose, hydroxypropylcellulose, ethylcellulose, carboxymethylcellulose, cellulose acetate phthalate, nitrocellulose and other cellulose ethers/esters; and guar derivatives such as hydroxypropyl guar.

The water-soluble polymer may include starch. As used herein, the term “starch” includes both naturally occurring or modified starches. Typical natural sources for starches can include cereals, tubers, roots, legumes and fruits. More specific natural sources can include corn, pea, potato, banana, barley, wheat, rice, sago, amaranth, tapioca, arrowroot, canna, sorghum, and waxy or high amylase varieties thereof. The natural starches can be modified by any modification method known in the art to form modified starches, including physically modified starches, such as sheared starches or thermally-inhibited starches; chemically modified starches, such as those which have been cross-linked, acetylated, and organically esterified, hydroxyethylated, and hydroxypropylated, phosphorylated, and inorganically esterified, cationic, anionic, nonionic, amphoteric and zwitterionic, and succinate and substituted succinate derivatives thereof; conversion products derived from any of the starches, including fluidity or thin-boiling starches prepared by oxidation, enzyme conversion, acid hydrolysis, heat or acid dextrinization, thermal and or sheared products may also be useful herein; and pregelatinized starches which are known in the art.

Water-soluble polymers may include polyvinyl alcohols, polyvinylpyrrolidones, polyalkylene oxides, starch and starch derivatives, pullulan, gelatin, hydroxypropylmethylcelluloses, methycelluloses, and carboxymethycelluloses. In one example, the water-soluble polymers include polyvinyl alcohols, and/or hydroxypropylmethylcelluloses.

Polyvinyl alcohols may be characterized by a degree of hydrolysis ranging from about 40% to about 100%, from about 50% to about 95%, from about 65% to about 92%, or from about 70% to about 90%. Commercially available polyvinyl alcohols include those from Celanese Corporation (Texas, USA) under the CELVOL trade name including, but not limited to, CELVOL 523, CELVOL 530, CELVOL 540, CELVOL 518, CELVOL 513, CELVOL 508, CELVOL 504; those from Kuraray Europe GmbH (Frankfurt, Germany) under the Mowiol® and POVAL™ trade names; and PVA 1788 (also referred to as PVA BP17) commercially available from various suppliers including Lubon Vinylon Co. (Nanjing, China); and combinations thereof. The flexible, porous, dissolvable solid sheet may comprise from about 10% to about 25%, or from about 15% to about 23%, by total weight of such sheet, of a polyvinyl alcohol having a weight average molecular weight ranging from 80,000 to about 150,000 Daltons and a degree of hydrolysis ranging from about 80% to about 90%.

In addition to polyvinyl alcohols as mentioned hereinabove, a single starch or a combination of starches may be used as a filler material in such an amount as to reduce the overall level of water-soluble polymers required, so long as it helps provide the solid sheet with the requisite structure and physical/chemical characteristics as described herein. However, too much starch may comprise the solubility and structural integrity of the sheet. Therefore, it is desired that the solid sheet comprises no more than 20%, from 0% to 10%, from 0% to 5%, from 0% to 1%, by weight of the solid sheet, of starch.

### Surfactants

In addition to the water-soluble polymer described hereinabove, the solid sheet comprises a surfactant. The surfactant may function as emulsifying agents during the aeration process to create a sufficient amount of stable bubbles for forming the desired OCF structure. Further, the surfactant may function as active ingredients for delivering a desired cleansing benefit.

The solid sheet may comprise a surfactant selected from the group consisting of anionic surfactants, nonionic surfactants, cationic surfactants, zwitterionic surfactants, amphoteric surfactants, polymeric surfactants and any combinations thereof. Depending on the desired application of such solid sheet and the desired consumer benefit to be achieved, different surfactants can be selected. One benefit is that the OCF structures of the solid sheet allow for incorporation of a high surfactant content while still providing fast dissolution. Consequently, highly concentrated cleansing compositions can be formulated into the solid sheets to provide a new and superior cleansing experience to the consumers.

The surfactant as used herein may include both surfactants from the conventional sense (i.e., those providing a consumer-noticeable lathering effect) and emulsifiers (i.e., those that do not provide any lathering performance but are intended primarily as a process aid in making a stable foam structure). Examples of emulsifiers for use as a surfactant component herein include mono- and di-glycerides, fatty alcohols, polyglycerol esters, propylene glycol esters, sorbitan esters and other emulsifiers known or otherwise commonly used to stabilize air interfaces.

The total amount of the surfactant present In the solid sheet may range widely from about 5% to about 95%, from about 30% to about 90%, from about 40% to about 80%, from about 50% to about 70%, e.g. 20%, 30%, 40%, 50%, 60%, 70%, 80% or any ranges therebetween, by total weight of the solid sheet. Correspondingly, the wet pre-mixture may comprise from about 1% to about 50% by weight of the wet pre-mixture of surfactant(s), in one example from about 2% to about 40% by weight of the wet pre-mixture of surfactant(s), in one example from about 10% to about 35% by weight of the wet pre-mixture of surfactant(s), in one example from about 15% to about 30% by weight of the wet pre-mixture of surfactant(s).

Non-limiting examples of anionic surfactants suitable for use herein include alkyl and alkyl ether sulfates, sulfated monoglycerides, sulfonated olefins, alkyl aryl sulfonates, primary or secondary alkane sulfonates, alkyl sulfosuccinates, acyl taurates, acyl isethionates, alkyl glycerylether sulfonate, sulfonated methyl esters, sulfonated fatty acids, alkyl phosphates, acyl glutamates, acyl sarcosinates, alkyl sulfoacetates, acylated peptides, alkyl ether carboxylates, acyl lactylates, anionic fluorosurfactants, sodium lauroyl glutamate, and combinations thereof.

One category of anionic surfactants particularly suitable for practice herein include C₆-C₂₀ linear alkylbenzene sulphonate (LAS) surfactant. LAS surfactants are well known in the art and can be readily obtained by sulfonating commercially available linear alkylbenzenes. Exemplary C₁₀-C₂₀ linear alkylbenzene sulfonates that can be used herein include alkali metal, alkaline earth metal or ammonium salts of C₁₀-C₂₀ linear alkylbenzene sulfonic acids, and the sodium, potassium, magnesium and/or ammonium salts of C₁₁-C₁₈ or C₁₁-C₁₄ linear alkylbenzene sulfonic acids. It may be the sodium or potassium salts of C₁₂ and/or C₁₄ linear alkylbenzene sulfonic acids, i.e., sodium dodecylbenzene sulfonate and/or sodium tetradecylbenzene sulfonate.

LAS provides superior cleaning benefit and is especially suitable for use in laundry detergent applications. It has been a surprising and unexpected discovery herein that when polyvinyl alcohol having a higher weight average molecular weight (e.g., from about 50,000 to about 400,000 Daltons, from about 60,000 to about 300,000 Daltons, from about 70,000 to about 200,000 Daltons, from about 80,000 to about 150,000 Daltons) is used as the film-former and carrier, LAS can be used as a major surfactant, i.e., present in an amount that is more than 50% by weight of the total surfactant content in the solid sheet, without adversely affecting the film-forming performance and stability of the overall composition. Correspondingly, in a particular example, LAS is used as the major surfactant in the solid sheet. If present, the amount of LAS in the solid sheet may range from about 10% to about 70%, from about 20% to about 65%, from about 40% to about 60%, by total weight of the solid sheet.

Another category of anionic surfactants suitable for practice herein include sodium trideceth sulfates (STS) having a weight average degree of alkoxylation ranging from about 0.5 to about 5, from about 0.8 to about 4, from about 1 to about 3, from about 1.5 to about 2.5. Trideceth is a 13-carbon branched alkoxylated hydrocarbon comprising, in one example, an average of at least 1 methyl branch per molecule. STS used by the present disclosure may be include ST(eOxPOy)S, while eOx refers to repeating ethylene oxide units with a repeating number x ranging from 0 to 5, from 1 to 4, from 1 to 3, and while pOy refers to repeating propylene oxide units with a repeating number y ranging from 0 to 5, from 0 to 4, from 0 to 2. It is understood that a material such as ST2S with a weight average degree of ethoxylation of about 2, for example, may comprise a significant amount of molecules which have no ethoxylate, 1 mole ethoxylate, 3 mole ethoxylate, and so on, while the distribution of ethoxylation can be broad, narrow or truncated, which still results in an overall weight average degree of ethoxylation of about 2. STS is particularly suitable for personal cleansing applications, and it has been a surprising and unexpected discovery herein that when polyvinyl alcohol having a higher weight average molecular weight (e.g., from about 50,000 to about 400,000 Daltons, from about 60,000 to about 300,000 Daltons, from about 70,000 to about 200,000 Daltons, from about 80,000 to about 150,000 Daltons) is used as the film-former and carrier, STS can be used as a major surfactant, i.e., present in an amount that is more than 50% by weight of the total surfactant content in the solid sheet, without adversely affecting the film-forming performance and stability of the overall composition. Correspondingly, in a particular example herein, STS is used as the major surfactant in the solid sheet. If present, the amount of STS in the solid sheet may range from about 10% to about 70%, from about 20% to about 65%, from about 40% to about 60%, by total weight of the solid sheet.

Another category of anionic surfactants suitable for practice include alkyl sulfates. These materials have the respective formulae ROSO₃M, wherein R is alkyl or alkenyl of from about 6 to about 20 carbon atoms, x is 1 to 10, and M is a water-soluble cation such as ammonium, sodium, potassium and triethanolamine. R may have from about 6 to about 18, from about 8 to about 16, from about 10 to about 14, carbon atoms. Previously, unalkoxylated C₆-C₂₀ linear or branched alkyl sulfates (AS) have been considered the preferred surfactants in dissolvable solid sheets, especially as the major surfactant therein, due to its compatibility with low molecular weight polyvinyl alcohols (e.g., those with a weight average molecular weight of no more than 50,000 Daltons) in film-forming performance and storage stability. However, it has been a surprising and unexpected discovery that when polyvinyl alcohol having a higher weight average molecular weight (e.g., from about 50,000 to about 400,000 Daltons, from about 60,000 to about 300,000 Daltons, from about 70,000 to about 200,000 Daltons, from about 80,000 to about 150,000 Daltons) is used as the film-former and carrier, other surfactants, such as LAS and/or STS, can be used as the major surfactant in the solid sheet, without adversely affecting the film-forming performance and stability of the overall composition. Therefore, it is desirable to provide a solid sheet with no more than about 20%, from 0% to about 10%, from 0% to about 5%, from 0% to about 1%, by weight of the solid sheet, of AS.

Another category of anionic surfactants includes C₆-C₂₀ linear or branched alkylalkoxy sulfates (AAS). Among this category, linear or branched alkylethoxy sulfates (AES) having the respective formulae RO(C₂H₄O)ₓSO₃M can be utilized, wherein R is alkyl or alkenyl of from about 6 to about 20 carbon atoms, x is 1 to 10, and M is a water-soluble cation such as ammonium, sodium, potassium and triethanolamine. R may have from about 6 to about 18, from about 8 to about 16, from about 10 to about 14, carbon atoms.

Nonionic surfactants that can be included into the solid sheet may be any conventional nonionic surfactants, including but not limited to: alkyl alkoxylated alcohols, alkyl alkoxylated phenols, alkyl polysaccharides (especially alkyl glucosides and alkyl polyglucosides), polyhydroxy fatty acid amides, alkoxylated fatty acid esters, sucrose esters, sorbitan esters and alkoxylated derivatives of sorbitan esters, amine oxides, and the like. Nonionic surfactants can include those of the formula R¹(OC₂H₄)ₙOH, wherein R¹ is a C₈-C₁₈ alkyl group or alkyl phenyl group, and n is from about 1 to about 80. For example, C₈-C₁₈ alkyl ethoxylated alcohols having a weight average degree of ethoxylation from about 1 to about 20, from about 5 to about 15, from about 7 to about 10, such as NEODOL® nonionic surfactants commercially available from Shell can be used. Other non-limiting examples of nonionic surfactants useful herein include: C₆-C₁₂ alkyl phenol alkoxylates where the alkoxylate units may be ethyleneoxy units, propyleneoxy units, or a mixture thereof; C₁₂-C₁₈ alcohol and C₆-C₁₂ alkyl phenol condensates with ethylene oxide/propylene oxide block polymers such as Pluronic® from BASF; C₁₄-C₂₂ mid-chain branched alcohols (BA); C₁₄-C₂₂ mid-chain branched alkyl alkoxylates, BAEₓ, wherein x is from 1 to 30; alkyl polysaccharides, specifically alkyl polyglycosides; Polyhydroxy fatty acid amides; and ether capped poly(oxyalkylated) alcohol surfactants. Suitable nonionic surfactants also include those sold under the tradename Lutensol® from BASF.

One example of a nonionic is a C₆-C₂₀ linear or branched alkylalkoxylated alcohols (AA) having a weight average degree of alkoxylation ranging from 5 to 15, C₁₂-C₁₄ linear ethoxylated alcohols having a weight average degree of alkoxylation ranging from 7 to 9. If present, the amount of AA-type nonionic surfactant(s) in the solid sheet may range from about 2% to about 40%, from about 5% to about 30%, or from about 8% to about 12%, by total weight of the solid sheet.

Amphoteric surfactants suitable for use in the solid sheet includes those that are broadly described as derivatives of aliphatic secondary and tertiary amines in which the aliphatic radical can be straight or branched chain and wherein one of the aliphatic substituents contains from about 8 to about 18 carbon atoms and one contains an anionic water solubilizing group, e.g., carboxy, sulfonate, sulfate, phosphate, or phosphonate. Examples of compounds falling within this definition are sodium 3-dodecyl-aminopropionate, sodium 3-dodecylaminopropane sulfonate, sodium lauryl sarcosinate, N-alkyltaurines such as the one prepared by reacting dodecylamine with sodium isethionate, and N-higher alkyl aspartic acids.

Zwitterionic surfactants suitable include those that are broadly described as derivatives of aliphatic quaternary ammonium, phosphonium, and sulfonium compounds, in which the aliphatic radicals can be straight or branched chain, and wherein one of the aliphatic substituents contains from about 8 to about 18 carbon atoms and one contains an anionic group, e.g., carboxy, sulfonate, sulfate, phosphate, or phosphonate. Such suitable zwitterionic surfactants can be represented by the formula:

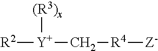

wherein R² contains an alkyl, alkenyl, or hydroxy alkyl radical of from about 8 to about 18 carbon atoms, from 0 to about 10 ethylene oxide moieties and from 0 to about 1 glyceryl moiety; Y is selected from the group consisting of nitrogen, phosphorus, and sulfur atoms; R³ is an alkyl or monohydroxyalkyl group containing about 1 to about 3 carbon atoms; X is 1 when Y is a sulfur atom, and 2 when Y is a nitrogen or phosphorus atom; R⁴ is an alkylene or hydroxyalkylene of from about 1 to about 4 carbon atoms and Z is a radical selected from the group consisting of carboxylate, sulfonate, sulfate, phosphonate, and phosphate groups.

Cationic surfactants can also be utilized herein, especially in fabric softener and hair conditioner products. When used in making products that contain cationic surfactants as the major surfactants, such cationic surfactants may be present in an amount ranging from about 2% to about 30%, from about 3% to about 20%, or from about 5% to about 15% by total weight of the solid sheet.

Cationic surfactants may include DEQA compounds, which encompass a description of diamido actives as well as actives with mixed amido and ester linkages. DEQA compounds are typically made by reacting alkanolamines such as MDEA (methyldiethanolamine) and TEA (triethanolamine) with fatty acids. Some materials that typically result from such reactions include N,N-di(acyl-oxyethyl)-N,N-dimethylammonium chloride or N,N-di(acyl-oxyethyl)-N,N-methylhydroxyethylammonium methylsulfate wherein the acyl group is derived from animal fats, unsaturated, and polyunsaturated, fatty acids.

Suitable polymeric surfactants for use in the personal care compositions include, but are not limited to, block copolymers of ethylene oxide and fatty alkyl residues, block copolymers of ethylene oxide and propylene oxide, hydrophobically modified polyacrylates, hydrophobically modified celluloses, silicone polyethers, silicone copolyol esters, diquaternary polydimethylsiloxanes, and co-modified amino/polyether silicones.

The surfactant may be selected from the group consisting of a C₆-C₂₀ linear alkylbenzene sulfonate (LAS), a C₆-C₂₀ linear or branched alkylalkoxy sulfates (AAS) having a weight average degree of alkoxylation ranging from 0.5 to 10, a C₆-C₂₀ linear or branched alkylalkoxylated alcohols (AA) having a weight average degree of alkoxylation ranging from 5 to 15, a C₆-C₂₀ linear or branched alkyl sulfates (AS) and any combinations thereof.

### Plasticizers

The flexible, porous, dissolvable solid sheet may further comprise a plasticizer, in the amount ranging from about 0.1% to about 25%, from about 0.5% to about 20%, from about 1% to about 15%, or from 2% to 12%, by total weight of the solid sheet. Correspondingly, the wet pre-mixture used for forming such solid sheet may comprise from about 0.02% to about 20% of a plasticizer by weight of the wet pre-mixture, in one example from about 0.1% to about 10% of a plasticizer by weight of the wet pre-mixture, in one example from about 0.5% to about 5% of a plasticizer by weight of the wet pre-mixture.

Suitable plasticizers for use herein include, for example, polyols, copolyols, polycarboxylic acids, polyesters, dimethicone copolyols, and the like.

Examples of useful polyols include, but are not limited to: glycerin, diglycerin, ethylene glycol, polyethylene glycol (especially 200-600), propylene glycol, butylene glycol, pentylene glycol, glycerol derivatives (such as propoxylated glycerol), glycidol, cyclohexane dimethanol, hexanediol, 2,2,4-trimethylpentane-1,3-diol, pentaerythritol, urea, sugar alcohols (such as sorbitol, mannitol, lactitol, xylitol, maltitol, and other mono- and polyhydric alcohols), mono-, di- and oligo-saccharides (such as fructose, glucose, sucrose, maltose, lactose, high fructose corn syrup solids, and dextrins), ascorbic acid, sorbates, ethylene bisformamide, amino acids, and the like.

Examples of polycarboxylic acids include, but are not limited to citric acid, maleic acid, succinic acid, polyacrylic acid, and polymaleic acid.

Examples of suitable polyesters include, but are not limited to, glycerol triacetate, acetylated-monoglyceride, diethyl phthalate, triethyl citrate, tributyl citrate, acetyl triethyl citrate, acetyl tributyl citrate.

Examples of suitable dimethicone copolyols include, but are not limited to, PEG-12 dimethicone, PEG/PPG-18/18 dimethicone, and PPG-12 dimethicone.

Examples of plasticizers include glycerin, ethylene glycol, polyethylene glycol, propylene glycol, or a mixture thereof.

### Additional Ingredients

In addition to the above-described ingredients, e.g., the water-soluble polymer, the surfactant(s) and the plasticizer, the solid sheet may comprise one or more additional ingredients, depending on its intended application. Such one or more additional ingredients may be selected from the group consisting of fabric care actives, dishwashing actives, hard surface cleaning actives, beauty and/or skin care actives, personal cleansing actives, hair care actives, oral care actives, feminine care actives, baby care actives, a bittering agent and any combinations thereof. The solid sheet may comprise a bittering agent.

The solid sheet may further comprise other optional ingredients that are known for use or otherwise useful in compositions, provided that such optional materials are compatible with the selected essential materials described herein, or do not otherwise unduly impair product performance.

Non-limiting examples of product type examples that can be formed by the solid sheet include laundry detergent products, fabric softening products, hand cleansing products, hair shampoo or other hair treatment products, body cleansing products, shaving preparation products, dish cleaning products, personal care substrates containing pharmaceutical or other skin care actives, moisturizing products, sunscreen products, beauty or skin care products, deodorizing products, oral care products, feminine cleansing products, baby care products, fragrance-containing products, and so forth.

Particulate Material A solid article can include a particulate material. A particulate material can comprise one or more at least partially water insoluble particles which comprise a first component, preferably an active component, and a second component, preferably a non-active component. The particulate material may be within a single sheet, sandwiched between multiple sheets, or a combination thereof.

It has been unexpectedly discovered that some active agents may be coupled with and/or include other components, like non-active components, which may greatly contribute to residue seen on fabrics after washing. This disclosure focuses on a particulate material that may be included in a solid article which can include one or more at least partially water insoluble particles.

Particles or clusters of particles may be distributed in pockets distributed in a layer, where such pockets may be formed between layers; the contact network and porosity within each cluster of particles is governed by physics of conventional particle packing, yet the clusters are substantially dilated in the layer. The particles or clusters of particles may be distributed relatively homogeneously throughout the structure, substantially free of local particle clusters; packing is substantially dilated on the scale of individual particles, with fewer inter-particle contacts and greater inter-particle porosity. Without wishing to be bound by theory, it is believed that a water-soluble soluble article comprising a layer comprising elements and particles, where sticky surfactants, such as AES, are segregated into particles having a dilated structure, provides for an improvement in dispersion and dissolution of the solid article, both by faster imbibition of water into the dilated structure and by a reduction in contacts among particles having sticky surfactants.

The particulate material may comprise at least one particle which is at least partially water insoluble. Each particle may comprise a first component, preferably an active, and a second component, preferably a non-active component. These second components, preferably non-active components, may be insoluble or partially soluble. The non-active components may comprise a filler, a carrier, a structurant, a builder, a cellulosic polymer, or a mixture thereof.

The active components be selected from a surfactant, an organic polymeric compound, an enzyme, an enzyme stabilizer, a bleach system, a brightener, a hueing agent, a chelating agent, a suds suppressor, a conditioning agent, a humectant, a perfume, a perfume microcapsule, an alkalinity system, a pH control system, a buffer, an alkanolamine, and mixtures thereof.

The particles or clusters of particles may have a particle size distribution such that the D100 is in a range of from about 1300 μm to about 20 μm, or about 1200 μm to about 50 μm, or about 1100 μm to about 100 μm, or about 1000 μm to about 200 μm, or about 900 μm to about 300 μm, or about 800 μm to about 400 μm, or about 700 μm to about 500 μm.

The particles or clusters of particles may have a particle size distribution such that the D50 is in a range of from about 1800 μm to about 25 μm, or about 1700 μm to about 50 μm, or about 1600 μm to about 100 μm, or about 1500 μm to about 200 μm, or about 1400 μm to about 300 μm, or about 1300 μm to about 400 μm, or about 1200 μm to about 500 μm, or about 1100 μm to about 600 μm, or about 1000 μm to about 700 μm, or about 900 μm to about 800 μm.

### Non-Active Components

As previously expressed, non-active components are components or substances present in a formulation or product that do not constitute the primary active component responsible for producing the intended functional effect. Non-active components may server a variety of other functions and may be generally classified according to those other functions. It is to be appreciated, however, that non-active components may server more than one function and that some overlap is to be expected. Therefore, the following categories should not be construed overly rigidly; many of the examples given for each category may be reasonably classified into other categories. An attempt has been made, however, to categorize the examples of many non-active components by the primary function as a filler, a carrier, a structurant, or a builder.

### Filler

Generally, a filler is a non-active component that primarily serves to enhance the bulk and volume of the detergent formulation. Fillers, such as soluble salts (e.g., sodium sulfate, sodium chloride, sodium carbonate), contribute to the physical structure of the detergent product without actively participating in the cleaning process. They are employed to optimize the product's form and economic efficiency. These fillers serve a primarily structural or economic purpose, contributing to the overall physical integrity of the detergent product and facilitating cost-effective manufacturing. While fillers do not actively participate in the cleaning process, they play a crucial role in optimizing the detergent's physical characteristics, such as its appearance, texture, and handling properties. Sodium sulfate, sodium chloride, and sodium carbonate may be employed as fillers due to their solubility in water and compatibility with detergent formulations. It is to be appreciated that other examples of suitable fillers may be identified and employed based on these criteria.

### Carrier

A carrier may serve as a medium for the even distribution and dispersion of active components, facilitating their effective delivery during use. A carrier may aid in optimizing the solubility and dispersibility of cleaning agents in the wash. Examples of carriers include inorganic salts, clays, starches, cyclodextrins, as well as derivatives thereof and/or combinations thereof. Examples of inorganic salts include but are not limited to magnesium carbonate, calcium carbonate, potassium carbonate, derivatives thereof, and/or combinations thereof. Examples of clays include but are not limited to kaolin, bentonite, montmorillonite, illite, derivatives thereof, and/or combinations thereof. Examples of cyclodextrans include but are not limited to alpha-cyclodextrin, beta-cyclodextrin, and gamma-cyclodextrin, derivatives thereof, and/or combinations thereof.

### Structurant

A structuring agent or a structurant is a component that imparts a specific physical structure or form to the solid laundry detergent. It contributes to the overall stability and coherence of the product. Structuring agents play a role in shaping the detergent into a desired form, such as tablets or bars, and help maintain its structural integrity during storage and use. While fillers may also contribute to structure, structuring agents specifically focus on shaping the detergent product.

Examples of structurants include silicates, including but not limited to sodium silicates. A structurant may comprise one or more suitable cellulosic polymers and/or their derivates including those selected from microcrystalline cellulose, alkyl cellulose, alkyl alkoxyalkyl cellulose, carboxyalkyl cellulose, alkyl carboxyalkyl cellulose. The cellulosic polymers may be selected from the group consisting of carboxymethyl cellulose, methyl cellulose, methyl hydroxyethyl cellulose, methyl carboxymethyl cellulose, and mixtures thereof. In one aspect, the carboxymethyl cellulose has a degree of carboxymethyl substitution from 0.5 to 0.9 and a molecular weight from about 20,000 Da to about 300,000 Da, or about 30,000 Da to about 290,000 Da, or about 40,000 Da to about 280,000 Da, or about 50,000 Da to about 270,000 Da, or about 60,000 Da to about 260,000 Da, or about 70,000 Da to about 250,000 Da, or about 80,000 Da to about 240,000 Da, or about 90,000 Da to about 230,000 Da, or about 100,000 Da to about 220,000 Da, or about 110,000 Da to about 210,000 Da, or about 100,000 Da to about 200,000 Da, or about 110,000 Da to about 190,000 Da, or about 120,000 Da to about 180,000 Da, or about 140,000 Da to about 170,000 Da, or about 130,000 Da to about 160,000 Da, or about 140,000 Da to about 150,000 Da.

### Builders

Builders are components in a formulation that primarily contribute to water softening, ion exchange, or complexation reactions, enhancing the overall cleaning efficiency of the product. They are not the primary active agents responsible for the intended functional effect of the detergent, which is typically the cleaning action.

Suitable builders include aluminosilicates (e.g., zeolite builders, such as zeolite A, zeolite P, and zeolite MAP), silicates, phosphates, such as polyphosphates (e.g., sodium tri-polyphosphate), especially sodium salts thereof; carbonates, bicarbonates, sesquicarbonates, and carbonate minerals other than sodium carbonate or sesquicarbonate; organic mono-, di-, tri-, and tetracarboxylates, especially water-soluble nonsurfactant carboxylates in acid, sodium, potassium or alkanolammonium salt form, as well as oligomeric or water-soluble low molecular weight polymer carboxylates including aliphatic and aromatic types; and phytic acid. Additional suitable builders may be selected from citric acid, lactic acid, fatty acid, polycarboxylate builders, for example, copolymers of acrylic acid, copolymers of acrylic acid and maleic acid, and copolymers of acrylic acid and/or maleic acid, and other suitable ethylenic monomers with various types of additional functionalities. Alternatively, the composition may be substantially free of builder.

### Active Components

As previously expressed, active components are key components or substances present in a formulation or product that constitute the primary agents responsible for producing the intended functional effect. Active components play diverse roles and can be broadly classified according to their distinct functions. It is important to acknowledge that active components may serve more than one function, and some overlap is to be anticipated. Therefore, the subsequent categories should not be construed overly rigidly; many of the examples given for each category may be reasonably classified into other categories. An attempt has been made, however, to categorize the examples of many active components by their primary function. The following list outlines types of active components, including surfactants, enzymes, polymeric dispersing agents, soil release polymers, amines, bleaching agents, bleach catalysts, brightness agents, fabric softening agents, encapsulates, perfumes, dye transfer inhibiting agents, chelating agents, suds suppressors, suds boosters, conditioning agents, fabric enhancement agents, pearlescent agents, hygiene and malodor agents, and buffer systems. Each active component contributes uniquely to the overall efficacy and performance of the formulation, working collectively to achieve the intended functional effects in the end product.

### Surfactant

The surfactant may be selected from the group consisting of anionic surfactants, nonionic surfactants, cationic surfactants, zwitterionic surfactants, amphoteric surfactants, ampholytic surfactants, and mixtures thereof. These surfactants are described in more detail above.

### Enzymes

Examples of suitable enzymes include, but are not limited to, hemicellulases, peroxidases, proteases, cellulases, xylanases, lipases, phospholipases, esterases, cutinases, pectinases, mannanases, pectate lyases, keratinases, reductases, oxidases, phenoloxidases, lipoxygenases, ligninases, pullulanases, tannases, pentosanases, malanases, β-glucanases, arabinosidases, hyaluronidase, chondroitinase, laccase, and amylases, or mixtures thereof. A typical combination is an enzyme cocktail that may comprise, for example, a protease and lipase in conjunction with amylase. When present in a detergent composition, the aforementioned additional enzymes may be present at levels from about 0.00001% to about 2%, from about 0.0001% to about 1% or even from about 0.001% to about 0.5% enzyme protein by weight of the composition. The compositions disclosed herein may comprise from about 0.001% to about 1% by weight of an enzyme (as an adjunct), which may be selected from the group consisting of lipase, amylase, protease, mannanase, cellulase, pectinase, and mixtures thereof.

### Polymeric Dispersing Agents

Suitable polymers include, but are not limited to, polymeric carboxylates, such as polyacrylates, poly acrylic-maleic co-polymers, and sulfonated modifications thereof, for example, a hydrophobically modified sulfonated acrylic acid copolymer. The polymer may be a cellulosic based polymer, a polyester, a polyterephthalate, a polyethylene glycol, an ethylene oxide-propylene oxide-ethylene oxide (EOx₁POyEOx₂) triblock copolymer, where each of x1 and X2 is in the range of about 2 to about 140 and y is in the range of from about 15 to about 70, a polyethyleneimine, any modified variant thereof, such as polyethylene glycol having grafted vinyl and/or alcohol moieties, and any combination thereof. In some cases, the dispersant polymer may also function as a rheology modifier, as described above.

Suitable polyethyleneimine polymers include propoxylated polyalkylenimine (e.g., PEI) polymers. The propoxylated polyalkylenimine (e.g., PEI) polymers may also be ethoxylated. The propoxylated polyalkylenimine (e.g., PEI) polymers may have inner polyethylene oxide blocks and outer polypropylene oxide blocks, the degree of ethoxylation and the degree of propoxylation not going above or below specific limiting values. The ratio of polyethylene blocks to polypropylene blocks (n/p) may be from about 0.6, or from about 0.8, or from about 1, to a maximum of about 10, or a maximum of about 5, or a maximum of about 3. The n/p ratio may be about 2. The propoxylated polyalkylenimines may have PEI backbones having weight average molecular weights (as determined prior to alkoxylation) of from about 200 g/mol to about 1200 g/mol, or from about 400 g/mol to about 800 g/mol, or about 600 g/mol. The molecular weight of the propoxylated polyalkylenimines may be from about 8,000 to about 20,000 g/mol, or from about 10,000 to about 15,000 g/mol, or about 12,000 g/mol.

Suitable propoxylated polyalkylenimine polymers may include compounds of the following structure:

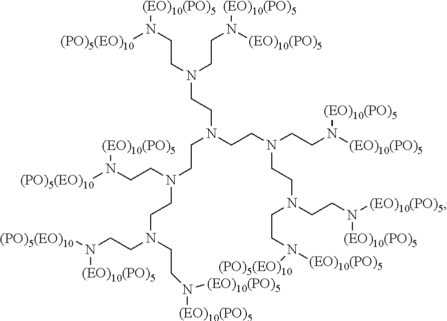

where EOs are ethoxylate groups and POs are propoxylate groups. The compound shown above is a PEI where the molar ratio of EO:PO is 10:5 (e.g., 2:1). Other similar, suitable compounds may include EO and PO groups present in a molar ratio of about 10:5 or about 24:16.

### Soil Release Polymer

Suitable soil release polymers have a structure as defined by one of the following structures (I), (II) or (III):

—[(OCHR¹—CHR²)ₐ—O—OC—Ar—CO—]ₐ (I)

—[(OCHR³—CHR⁴)_{b}—O—OC-sAr—CO—]ₑ (II)

—[(OCHR⁵—CHR⁶)_{c}—OR⁷]_{f} (III)
wherein:
a, b and c are from 1 to 200;
d, e and f are from 1 to 50;
Ar is a 1,4-substituted phenylene;
sAr is 1,3-substituted phenylene substituted in position 5 with SO₃Me;
Me is Li, K, Mg/2, Ca/2, Al/3, ammonium, mono-, di-, tri-, or tetraalkylammonium wherein the alkyl groups are C₁-C₁₈ alkyl or C₂-C₁₀ hydroxyalkyl, or mixtures thereof;
R¹, R², R³, R⁴, R⁵ and R⁶ are independently selected from H or C₁-C₁₈n- or iso-alkyl; and
R⁷ is a linear or branched C₁-C₁₈ alkyl, or a linear or branched C₂-C₃₀ alkenyl, or a cycloalkyl group with 5 to 9 carbon atoms, or a C₈-C₃₀ aryl group, or a C₆-C₃₀ arylalkyl group.

Suitable soil release polymers are polyester soil release polymers such as Repel-o-tex polymers, including Repel-o-tex SF, SF-2 and SRP6 supplied by Rhodia. Other suitable soil release polymers include Texcare polymers, including Texcare SRA100, SRA300, SRN100, SRN170, SRN240, SRN300 and SRN325 supplied by Clariant. Other suitable soil release polymers are Marloquest polymers, such as Marloquest SL supplied by Sasol.

### Amines

Non-limiting examples of amines may include, but are not limited to, polyetheramines, polyamines, oligoamines, triamines, diamines, pentamines, tetraamines, or combinations thereof. Specific examples of suitable additional amines include tetraethylenepentamine, triethylenetetraamine, diethylenetriamine, or a mixture thereof.

### Bleaching Agents

Suitable bleaching agents other than bleaching catalysts include 2,2′,thiophene-2,5-diylbis(benzoxazole), photobleaches, bleach activators, hydrogen peroxide, sources of hydrogen peroxide, pre-formed peracids and mixtures thereof. In general, when a bleaching agent is used, the detergent compositions of the present disclosure may comprise from about 0.1% to about 50% or even from about 0.1% to about 25% bleaching agent by weight of the detergent composition.

### Bleach Catalysts

Suitable bleach catalysts include, but are not limited to: iminium cations and polyions; iminium zwitterions; modified amines; modified amine oxides; N-sulphonyl imines; N-phosphonyl imines; N-acyl imines; thiadiazole dioxides; perfluoroimines; cyclic sugar ketones and mixtures thereof.

### Brighteners

Commercial fluorescent brighteners suitable for the present disclosure can be classified into subgroups, including but not limited to: derivatives of stilbene, pyrazoline, coumarin, benzoxazoles, carboxylic acid, methinecyanines, dibenzothiophene-5,5-dioxide, azoles, 5- and 6-membered-ring heterocycles, and other miscellaneous agents.

The fluorescent brightener may be selected from the group consisting of disodium 4,4′-bis{[4-anilino-6-morpholino-s-triazin-2-yl]-amino}-2,2′-stilbenedisulfonate (brightener 15, commercially available under the tradename Tinopal AMS-GX by BASF), disodium4,4′-bis{[4-anilino-6-(N-2-bis-hydroxyethyl)-s-triazine-2-yl]-amino}-2,2′-stilbenedisulonate (commercially available under the tradename Tinopal UNPA-GX by BASF), disodium 4,4′-bis{[4-anilino-6-(N-2-hydroxyethyl-N-methylamino)-s-triazine-2-yl]-amino}-2,2′-stilbenedisulfonate (commercially available under the tradename Tinopal SBM-GX by BASF). More preferably, the fluorescent brightener is disodium 4,4′-bis{[4-anilino-6-morpholino-s-triazin-2-yl]-amino}-2,2′-stilbenedisulfonate.

The brighteners may be added in particulate form or as a premix with a suitable solvent, for example nonionic surfactant, propanediol.

### Fabric Hueing Agents

A fabric hueing agent (sometimes referred to as shading, bluing or whitening agents) typically provides a blue or violet shade to fabric. Hueing agents can be used either alone or in combination to create a specific shade of hueing and/or to shade different fabric types. This may be provided for example by mixing a red and green-blue dye to yield a blue or violet shade. Hueing agents may be selected from any known chemical class of dye, including but not limited to acridine, anthraquinone (including polycyclic quinones), azine, azo (e.g., monoazo, disazo, trisazo, tetrakisazo, polyazo), including premetallized azo, benzodifurane and benzodifuranone, carotenoid, coumarin, cyanine, diazahemicyanine, diphenylmethane, formazan, hemicyanine, indigoids, methane, naphthalimides, naphthoquinone, nitro and nitroso, oxazine, phthalocyanine, pyrazoles, stilbene, styryl, triarylmethane, triphenylmethane, xanthenes and mixtures thereof.

Suitable fabric hueing agents include dyes, dye-clay conjugates, and organic and inorganic pigments. Suitable dyes also include small molecule dyes and polymeric dyes. Suitable small molecule dyes include small molecule dyes selected from the group consisting of dyes falling into the Colour Index (C.I.) classifications of Direct, Basic, Reactive or hydrolysed Reactive, Solvent or Disperse dyes for example that are classified as Blue, Violet, Red, Green or Black, and provide the desired shade either alone or in combination. Suitable polymeric dyes include polymeric dyes selected from the group consisting of polymers containing covalently bound (sometimes referred to as conjugated) chromogens, (dye-polymer conjugates), for example polymers with chromogens co-polymerized into the backbone of the polymer and mixtures thereof. Suitable polymeric dyes also include polymeric dyes selected from the group consisting of fabric-substantive colorants sold under the name of Liquitint® (Milliken, Spartanburg, S.C., USA), dye-polymer conjugates formed from at least one reactive dye and a polymer selected from the group consisting of polymers comprising a moiety selected from the group consisting of a hydroxyl moiety, a primary amine moiety, a secondary amine moiety, a thiol moiety and mixtures thereof. Suitable polymeric dyes also include polymeric dyes selected from the group consisting of Liquitint® Violet CT, carboxymethyl cellulose (CMC) covalently bound to a reactive blue, reactive violet or reactive red dye such as CMC conjugated with C.I. Reactive Blue 19, sold by Megazyme, Wicklow, Ireland under the product name AZO-CM-CELLULOSE, product code S-ACMC, alkoxylated triphenyl-methane polymeric colourants, alkoxylated thiophene polymeric colourants, and mixtures thereof.

The aforementioned fabric hueing agents can be used in combination (any mixture of fabric hueing agents can be used).

### Encapsulates

An encapsulate may comprise a core, a shell having an inner and outer surface, said shell encapsulating said core. The core may comprise any laundry care adjunct, though typically the core may comprise material selected from the group consisting of perfumes; brighteners; hueing dyes; insect repellants; silicones; waxes; flavors; vitamins; fabric softening agents; skin care agents in one aspect, paraffins; enzymes; anti-bacterial agents; bleaches; sensates; and mixtures thereof; and said shell may comprise a material selected from the group consisting of polyethylenes; polyamides; polyvinylalcohols, optionally containing other co-monomers; polystyrenes; polyisoprenes; polycarbonates; polyesters; polyacrylates; aminoplasts, in one aspect said aminoplast may comprise a polyureas, polyurethane, and/or polyureaurethane, in one aspect said polyurea may comprise polyoxymethyleneurea and/or melamine formaldehyde; polyolefins; polysaccharides, in one aspect said polysaccharide may comprise alginate and/or chitosan; gelatin; shellac; epoxy resins; vinyl polymers; water insoluble inorganics; silicone; and mixtures thereof.

Preferred encapsulates comprise perfume. Preferred encapsulates comprise a shell which may comprise melamine formaldehyde and/or cross linked melamine formaldehyde. Other preferred capsules comprise a polyacrylate based shell. Preferred encapsulates comprise a core material and a shell, said shell at least partially surrounding said core material, is disclosed. At least 75%, 85% or even 90% of said encapsulates may have a fracture strength of from 0.2 MPa to 10 MPa, and a benefit agent leakage of from 0% to 20%, or even less than 10% or 5% based on total initial encapsulated benefit agent. Preferred are those in which at least 75%, 85% or even 90% of said encapsulates may have (i) a particle size of from 1 microns to 80 microns, 5 microns to 60 microns, from 10 microns to 50 microns, or even from 15 microns to 40 microns, and/or (ii) at least 75%, 85% or even 90% of said encapsulates may have a particle wall thickness of from 30 nm to 250 nm, from 80 nm to 180 nm, or even from 100 nm to 160 nm. Formaldehyde scavengers may be employed with the encapsulates, for example, in a capsule slurry and/or added to a composition before, during or after the encapsulates are added to such composition.

Suitable capsules that can be made using known processes. Alternatively, suitable capsules can be purchased from Encapsys LLC of Appleton, Wis. USA. In a preferred aspect the composition may comprise a deposition aid, preferably in addition to encapsulates. Preferred deposition aids are selected from the group consisting of cationic and nonionic polymers. Suitable polymers include cationic starches, cationic hydroxyethylcellulose, polyvinylformaldehyde, locust bean gum, mannans, xyloglucans, tamarind gum, polyethyleneterephthalate and polymers containing dimethylaminoethyl methacrylate, optionally with one or more monomers selected from the group comprising acrylic acid and acrylamide.

### Perfumes

Non-limiting examples of perfume and perfumery components include, but are not limited to, aldehydes, ketones, esters, and the like. Other examples include various natural extracts and essences which can comprise complex mixtures of components, such as orange oil, lemon oil, rose extract, lavender, musk, patchouli, balsamic essence, sandalwood oil, pine oil, cedar, and the like. Finished perfumes can comprise extremely complex mixtures of such components. Finished perfumes may be included at a concentration ranging from about 0.01% to about 2% by weight of the detergent composition.

### Dye Transfer Inhibiting Agents

Dye transfer inhibiting agents are effective for inhibiting the transfer of dyes from one fabric to another during the cleaning process. Generally, such dye transfer inhibiting agents may include polyvinyl pyrrolidone polymers, polyamine N-oxide polymers, copolymers of N-vinylpyrrolidone and N-vinylimidazole, manganese phthalocyanine, peroxidases, and mixtures thereof. If used, these agents may be used at a concentration of about 0.0001% to about 10%, by weight of the composition, in some examples, from about 0.01% to about 5%, by weight of the composition, and in other examples, from about 0.05% to about 2% by weight of the composition.

### Chelating Agents

Suitable chelating agents include copper, iron and/or manganese chelating agents and mixtures thereof. Such chelating agents can be selected from the group consisting of phosphonates, amino carboxylates, amino phosphonates, succinates, polyfunctionally-substituted aromatic chelating agents, 2-pyridinol-N-oxide compounds, hydroxamic acids, carboxymethyl inulins and mixtures thereof. Chelating agents can be present in the acid or salt form including alkali metal, ammonium, and substituted ammonium salts thereof, and mixtures thereof. Other suitable chelating agents for use herein are the commercial DEQUEST series, and chelants from Monsanto, Akzo-Nobel, DuPont, Dow, the Trilon® series from BASF and Nalco.

### Suds Suppressors

Compounds for reducing or suppressing the formation of suds can be incorporated into the water-soluble solid articles. Suds suppression can be of particular importance in the so-called “high concentration cleaning process” and in front-loading style washing machines. Examples of suds supressors include monocarboxylic fatty acid and soluble salts therein, high molecular weight hydrocarbons such as paraffin, fatty acid esters (e.g., fatty acid triglycerides), fatty acid esters of monovalent alcohols, aliphatic C₁₈-C₄₀ ketones (e.g., stearone), N-alkylated amino triazines, waxy hydrocarbons preferably having a melting point below about 100° C., silicone suds suppressors, and secondary alcohols.

Additional suitable antifoams are those derived from phenylpropylmethyl substituted polysiloxanes.

The detergent composition may comprise a suds suppressor selected from organomodified silicone polymers with aryl or alkylaryl substituents combined with silicone resin and modified silica, which is modified silica. The detergent compositions may comprise from about 0.001% to about 4.0%, by weight of the composition, of such a suds suppressor.

The detergent composition comprises a suds suppressor selected from: a) mixtures of from about 80 to about 92% ethylmethyl, methyl (2-phenylpropyl) siloxane; from about 5 to about 14% MQ resin in octyl stearate; and from about 3 to about 7% modified silica; b) mixtures of from about 78 to about 92% ethylmethyl, methyl (2-phenylpropyl) siloxane; from about 3 to about 10% MQ resin in octyl stearate; from about 4 to about 12% modified silica; or c) mixtures thereof, where the percentages are by weight of the anti-foam.

### Suds Boosters

If high sudsing is desired, suds boosters such as the C₁₀-C₁₆ alkanolamides may be used. Some examples include the C₁₀-C₁₄ monoethanol and diethanol amides. If desired, water-soluble magnesium and/or calcium salts such as MgCl₂, MgSO₄, CaCl₂, CaSO₄, and the like, may be added at levels of about 0.1% to about 2% by weight of the detergent composition, to provide additional suds and to enhance grease removal performance.

### Conditioning Agents

Suitable conditioning agents include high melting point fatty compounds. The high melting point fatty compound useful herein has a melting point of 25° C. or higher, and is selected from the group consisting of fatty alcohols, fatty acids, fatty alcohol derivatives, fatty acid derivatives, and mixtures thereof. Suitable conditioning agents also include nonionic polymers and conditioning oils, such as hydrocarbon oils, polyolefins, and fatty esters.

Suitable conditioning agents include those conditioning agents characterized generally as silicones (e.g., silicone oils, polyoils, cationic silicones, silicone gums, high refractive silicones, and silicone resins), organic conditioning oils (e.g., hydrocarbon oils, polyolefins, and fatty esters) or combinations thereof, or those conditioning agents which otherwise form liquid, dispersed particles in the aqueous surfactant matrix herein.

### Fabric Enhancement Polymers

Suitable fabric enhancement polymers are typically cationically charged and/or have a high molecular weight. The fabric enhancement polymers may be a homopolymer or be formed from two or more types of monomers. The monomer weight of the polymer will generally be between 5,000 and 10,000,000, typically at least 10,000 and preferably in the range 100,000 to 2,000,000. Preferred fabric enhancement polymers will have cationic charge densities of at least 0.2 meq/gm, preferably at least 0.25 meq/gm, more preferably at least 0.3 meq/gm, but also preferably less than 5 meq/gm, more preferably less than 3 meq/gm, and most preferably less than 2 meq/gm at the pH of intended use of the composition, which pH will generally range from pH 3 to pH 9, preferably between pH 4 and pH 8. The fabric enhancement polymers may be of natural or synthetic origin.

### Pearlescent Agent

Non-limiting examples of pearlescent agents include: mica; titanium dioxide coated mica; bismuth oxychloride; fish scales; mono and diesters of alkylene glycol. The pearlescent agent may be ethyleneglycoldistearate (EGDS).

### Hygiene and Malodour

Suitable hygiene and malodor active agents include zinc ricinoleate, thymol, quaternary ammonium salts such as Bardac®, polyethylenimines (such as Lupasol® from BASF) and zinc complexes thereof, silver and silver compounds, especially those designed to slowly release Ag⁺ or nano-silver dispersions.

### Buffer System

The water-soluble solid articles described herein may be formulated such that, during use in aqueous cleaning operations, the wash water will have a pH of between about 7.0 and about 12, and in some examples, between about 7.0 and about 11. Techniques for controlling pH at recommended usage levels include the use of buffers, alkalis, or acids, and are well known to those skilled in the art. These include, but are not limited to, the use of sodium carbonate, citric acid or sodium citrate, lactic acid or lactate, monoethanol amine or other amines, boric acid or borates, and other pH-adjusting compounds well known in the art.

The detergent compositions herein may comprise dynamic in-wash pH profiles. Such detergent compositions may use wax-covered citric acid particles in conjunction with other pH control agents such that (i) about 3 minutes after contact with water, the pH of the wash liquor is greater than 10; (ii) about 10 minutes after contact with water, the pH of the wash liquor is less than 9.5; (iii) about 20 minutes after contact with water, the pH of the wash liquor is less than 9.0; and (iv) optionally, wherein, the equilibrium pH of the wash liquor is in the range of from about 7.0 to about 8.5.

### Exemplary Iterations

According to an one iteration, a laundry detergent composition or a solid article may comprise a particulate material. The particulate material may include one or more particles having an active component and a non-active component. Solid articles may include a water-flexible, porous, dissolvable sheet and the laundry detergent composition or at least the particulate material. The solid article may comprise a plurality of layers, and the particulate material or the laundry detergent composition may be dispersed between the plurality of layers. An exemplary non-active component may be from a filler, a carrier, a structurant, a builder, and combinations thereof. It is to be appreciated that other non-active components may also be employed. It is also to be appreciated that the active component may be any suitable active component, including but not limited to those described herein. Finally, it is to be appreciated that the laundry detergent composition or the solid article may comprise any suitable component, including but not limited to all components described herein.

The non-active component may have a dry particle size of from about 0.01 μm to about 50 μm, or from about 0.01 μm to about 20 μm, or from about 1 μm to about 15 μm, or from about 5 μm to about 10 μm. The dry particle size of the non-active component is measured before the non-active component is incorporated into the at least one particle. It is to be appreciated that upon exposure to water, the particle may optionally swell and/or may release all or a portion of the active component. For example, upon exposure to water at a temperature of from about 5° C. to 40° C., or about 10° C. to about 35° C. or about 15° C. to about 20° C., or about 10° C. to about 25° C., for a time of from about 5 minutes to about 60 minutes, or about 10 minutes to about 45 minutes, or about 15 minutes to about 30 minutes, or about 10 minutes to about 20 minutes, the at least one particle releases from about 1% to about 100%, or from about 5% to about 95%, or from about 10% to about 90%, or from about 20% to about 80%, or from about 30% to about 70%, or from about 40% to about 60%, or from about 50% of the active component and the remaining particle comprise non-active component and optionally some active component may have a particle size of from about 0.01 μm to about 75 μm, or about 0.01 μm to about 50 μm, or about 1 μm to about 40 μm, or about 5 μm to about 30 μm, or about 10 μm to about 20 μm, or about 0.01 μm to about 20 μm.

The non-active component may be soluble in water or partially soluble in water. The non-active component may have a solubility in water at 25 degrees Celsius of about 0 g/mL to about 10 g/mL, or about 1 g/mL to about 9 g/mL, or about 2 g/mL to about 8 g/mL, or about 3 g/mL to about 7 g/mL, or about 4 g/mL to about 6 g/mL, or about 5 g/mL. According to various embodiments, the solid article, the particulate material, the plurality of particles, and/or the at least one particle may avoid inclusion of non-active components meeting any of the above-mentioned solubilities and having a particle size that is too big and, therefore, likely to cause residue on fabric. For example, according to various embodiments, the at least one particle, the particulate material, and/or the unit does article may avoid any non-active components that are at least partially water-insoluble (or that meet any of the above-mentioned solubilities) and that also have an average dry particle size greater than about 50 μm, or greater than about 45 μm, or greater than about 40 μm, or greater than about 35 μm, or greater than about 30 μm, or greater than about 25 μm, or greater than about 20 μm, or greater than about 15 μm, or greater than about 10 μm, or greater than about 5 μm, or greater than about 1 μm, or greater than about 0.1 μm, or greater than about 0.01 μm. Typically, restricting the presence of non-active components that are at least partially water-insoluble having an average dry particle size of greater than about 20 μm is sufficient. According to various embodiments, the non-active component may have a dry particle size of from 1 μm to about 10 μm.

It is possible for the non-active component to swell upon exposure to water. Thus, various embodiments may ensure that the non-active component has a swelling index of less than 2, or of from about 1 to about 2, or from about 1.2 to about 1.8, or from about 1.4 to about 1.6. The non-active component may have a swelling-index-adjusted particle size of from about 0.01 μm to about 50 μm, or from about 1 μm to about 40 μm, or from about 5 μm to about 35 μm, or from about 10 μm to about 30 μm, or from about 15 μm to about 25 μm, or about 20 μm. According to various embodiments, the non-active component may be present in the particle, in one or more of the plurality of particles, in the particulate material distinctly from the particle or particles, and/or in the solid article distinctly from the particle, the particles, or the particulate material. For example, the at least one particle may comprise from greater than 0% to about 70%, or about 5% to about 65%, or about 10% to about 60%, or about 15% to about 55%, or about 20% to about 50%, or about 25% to about 45%, or about 30% to about 40%, or about 10% by weight of the non-active component based on the total weight of the at least one particle. As another example, the at least one particle may comprise from about 30%, or from about 30 to about 100%, or from about 40 to about 90%, or from about 50 to about 80%, or from about 60 to about 70%, or from about 90% to about 100% by weight of the active component based on the total weight of the at least one particle. As still another example, the particulate material may comprise from about 60%, or about 60% to 100%, or about 65% to 95%, or about 60% to 90%, or about 70% to 85%, or about 75% to 80%, or from about 90% to about 100% by weight based on the total weight of the solid article of a total amount of all non-active component present in the solid article. Indeed, according to some embodiments, the particulate material comprises all of the non-active component present in the solid article.

### Method of Making Solid Article

The solid articles as described herein can be made by any known method. Generally, in making a solid article, a pre-mixture of raw materials is formed. This pre-mixture can be aerated and dried. Exemplary methods of making solid articles can be found, for example, in US App. Pub. No. 2022/0112449 and WO2012138820, both of which are incorporated herein.

### EXAMPLES

The following examples are put forth to provide those of ordinary skill in the art with a complete disclosure and description of how to perform the methods, how to make, and how to use the compositions and compounds disclosed and claimed herein. Efforts have been made to ensure accuracy with respect to numbers (e.g., amounts, temperature, etc.), but some errors and deviations should be accounted for. The purpose of the following examples is not to limit the scope of the various embodiments, but merely to provide examples illustrating specific embodiments.

### Example 1

A purpose of this example is to demonstrate the preparation of four unit dose articles (Compositions 1 to 4). Compositions 1 and 2 contain particles that were prepared in a drum batch process to produce a mixed granulate (hereinafter, “production route 1”). Compositions 3 and 4 contain particles that were prepared in a fluidized bed process to produce a layered granulate (“production route 2”).

In the various compositions various components were employed, which are specified in detail in Table 1. Generally, in compositions 1-4, a non-woven fibrous web, (hereinafter, BW VT33 Web) was employed; a particulate laundry detergent composition comprising surfactants, chelant, polymer builder, and carbonate, (hereinafter, PolyAgg HT33) was employed; a suds suppressor was employed; an amylase was employed; a protease was employed; process aids, minors, and perfume were employed. The specific amounts of each component are listed in Table 1, along with the enzyme activity of the finished product. The material additions are shown at active material level in the finished product (FP).

TABLE 1

| | Composition | Composition | Composition | Composition |
|---|---|---|---|---|
| | 1 | 2 | 3 | 4 |
| NaAS (from fiber) | 3.76 | 3.76 | 3.76 | 3.76 |
| Genapol T250 (NI68-25)¹ | 4.88 | 4.88 | 4.88 | 4.88 |
| NaAE1S (SLE1S, from particle) | 18.94 | 18.94 | 18.94 | 18.94 |
| NaLAS (from fiber & particle) | 17.17 | 17.17 | 17.17 | 17.17 |
| PE20 (from particle)⁴ | 7.28 | 7.28 | 7.28 | 7.28 |
| Sodium Carbonate (from particle) | 9.82 | 9.82 | 9.82 | 9.82 |
| Sodium Sulfate (from particle) | 0.34 | 0.34 | 0.34 | 0.34 |
| Silica (from particle) | 10.93 | 10.93 | 10.93 | 10.93 |
| Trilon M Granule SG³ (MGDA) | 1.57 | 1.57 | 1.57 | 1.57 |
| AcuSol 455 (from particle) ⁵ | 4.77 | 4.77 | 4.77 | 4.77 |
| Zeolite (from Particle) | 0.44 | 0.44 | 0.44 | 0.44 |
| Citrate (trisodium) | 2.10 | 2.10 | 2.10 | 2.10 |
| PVOH 505² (from fiber) | 4.97 | 4.97 | 4.97 | 4.97 |
| PEOn10 (from fiber) | 0.43 | 0.43 | 0.43 | 0.43 |
| PEOn60k (from fiber) | 0.07 | 0.07 | 0.07 | 0.07 |
| NaOH (from particle) | 0.23 | 0.23 | 0.23 | 0.23 |
| AF8017⁶ Suds suppressor | 1.36 | 1.36 | 1.36 | 1.36 |
| Amylase (production route 1) ⁷ | 0.00 | 2.955 | 0.00 | 0.00 |
| 14.53 mg/g | | | | |
| Protease (production route 1) ⁷ | 0.00 | 7.455 | 0.00 | 0.00 |
| 33.17 mg/g | | | | |
| Amylase (production route 2) ⁸ | 0.00 | 0.00 | 2.955 | 0.864 |
| 48.1 mg/g | | | | |
| Protease (production route 2) ⁸ | 0.00 | 0.00 | 7.455 | 1.682 |
| 145.3 mg/g | | | | |
| Process aids, Perfume, Misc. & | To Balance | To Balance | To Balance | To Balance |
| Moisture | | | | |

¹Genapol T250 is a nonionic surfactant is commercially available from Clariant.
²Celvol PVOH 505 Mw 40,000-50,000 g/mol, 72-75% hydrolyzed, available from Kuraray America
³Trilon M SG is Methylglycinediacetic acid chelant commercially available from BASF.
⁴PE-20 is an ethoxylated polyethylene imine commercially available from BASF.
⁵ AcuSol 455 is a homopolymer of acrylic acid commercially available from Dow.
⁶Suds suppressor is AF-8017 commercially available from Dow.
⁷ Drum batch process to give ‘mixed' granulate.
⁸ Fluidized bed layered granulate.

Production route 1, the drum batch process for producing the mixed granulate, included combining and homogenizing the various solid components to create a uniform and consistent granular product. In this process, a large cylindrical drum or mixer was employed. The dry, raw materials were weighed and loaded into the drum. The drum was then rotated, using a variable speed and tilt mechanism, to ensure thorough mixing. During rotation, liquid components were sprayed onto the materials to facilitate adhesion. This controlled agitation and blending process continued until the desired level of uniformity was achieved. Once the mixture was homogeneous, it was discharged from the drum and was ready for testing as specified in Example 2.

Production route 2, the fluidized bed process, utilized a fluidized bed reactor or dryer. The dry, raw materials were introduced into the fluidized bed. Heated air or gas was then blown into the chamber from beneath, causing these materials to become suspended and to behave like a fluid. Additional liquid materials were then introduced through nozzles above the fluidized bed. As these additional liquid materials were sprayed or poured onto the fluidized core, they adhered to form distinct layers on the original raw materials. The controlled flow of the gas and the manipulation of process parameters like temperature, airflow, and spray rate determine the thickness and composition of each layer. This process continued until the desired layered granulate structure was achieved. Once complete, the product was removed and was ready for testing as specified in Example 2.

### Example 2

A purpose of this example is to demonstrate the impact of enzyme granulate production route on fabric residues. Three external replicates were completed for each composition. 1000 ml of tap water was measured into each tergotometer pot and cooled to 10° C. or heated to 25° C. 1.22 g of the composition being tested was then added and a timer started. After 20 minutes of dissolution, the full wash solution was taken from each tergotometer pot and filtered through the black fabric using a vacuum pump, 3-piece, 9 cm diameter Büchner funnel, and a PYREX® flask with a side arm. Table 2 summarizes the materials employed.

TABLE 2

| Material | Details | | Source (if applicable) |
|---|---|---|---|
| Wash Equipment | Tergotometer | | Copley Scientific Limited, |
| | | | Colwick Quays Business Park, |
| | | | Road No. 2, Nottingham, |
| | | | NG4 2JY, |
| | | | United Kingdom |
| Wash Volume | 1000 | ml | |
| Water Hardness | Tap water with | | |
| | about 7 gpg | | |
| | hardness | | |
| Water Temperature | 10° C. and 25° C. | | |
| Detergent addition | 1.22 | g | |
| Black fabric | C70 | | Empirical Manufacturing Company, |
| | | | 7637 Production Drive, Cincinnati, Ohio |
| | | | 45237, USA. |
| Black fabric filtration | Vacuum pump | | General Laboratory (with trap) |
| | Buckner funnel | | 3-piece, glass, 9 cm diameter |
| | Flask | | 1 L + Pyrex with side-arm. |
| Image and color of | Image analysis | | DIGIEYE ® system for textiles |
| residue | | | VeriVide Limited, Quartz Close, Warrens |
| | | | Business Park, Enderby, Leicester LE19 |
| | | | 4SG United Kingdom |

At the start of each test the black fabrics were weighed using a balance, so residue weight could be determined gravimetrically. Fabrics were left to dry at room temp over night before re-weighing and analyzing the CIELAB color space of any residue deposited on the fabric using the DIGI-EYE®.

The Lab Color Space (CIELAB color space): also referred to as L*a*b* is a color space defined by the International Commission on Illumination (CIE) in 1976. It expresses color as three values: L* for perceptual lightness, and a* and b* for the four unique colors of human vision: red, green, blue, and yellow. L* may range from 0 (black) to 100 (white); a* specifies redness-greenness and may range from negative values (green) to positive values (red); and b* specifies yellowness-blueness and may range from negative values (blue) to positive values (yellow). The CIELAB color space is device-independent, meaning that it is not tied to any device or display technology. This makes it a good choice for applications where color needs to be accurately represented on a variety of devices.

The color difference between two colors may be calculated by measuring the L*a*b* values for each color. The value of ΔE*ab, as specified in the following formula, is a measure of the perceived color difference between the two colors. The higher the value of ΔE*ab, the greater the perceived color difference.

$$Δ E * ab = √ ( {( Δ L * )}^{2} + {( Δ a * )}^{2} + {( Δ b * )}^{2} )$$

where ΔL*, Δa*, and Δb* are the differences in the L*, a*, and b* values between the two colors.

$$Δ {L}^{*} = {L}_{washed} - {L}_{initial} \\ Δ {a}^{*} = {a}_{washed} - {a}_{initial} \\ Δ {b}^{*} = {b}_{washed} - {b}_{initial}$$

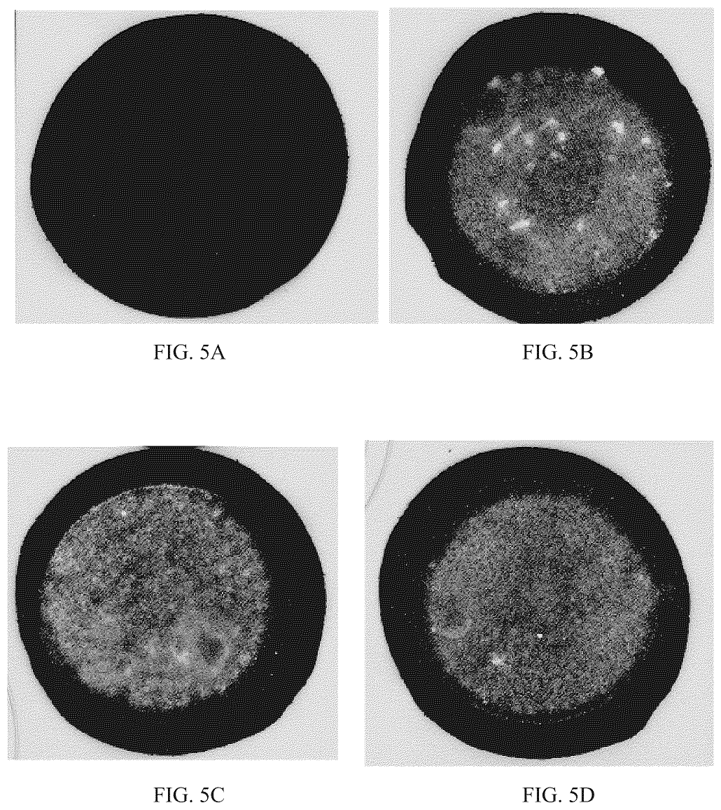

With reference to FIG. 5A, L*, a*, and b* measurements were taken by analyzing a test fabric 1 comprising one or more residue portions 2. The measurements were taken over the full area encompassed by a perimeter 3 surrounding all of the one or more residue portions 2 on the fabric 1. The perimeter 3 was a circle having a radius of about 450 mm.

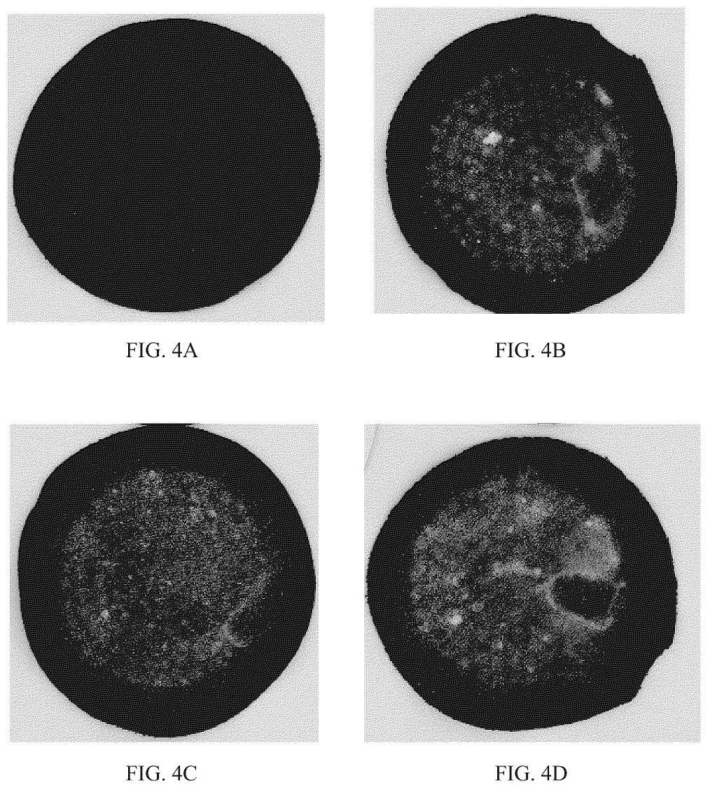

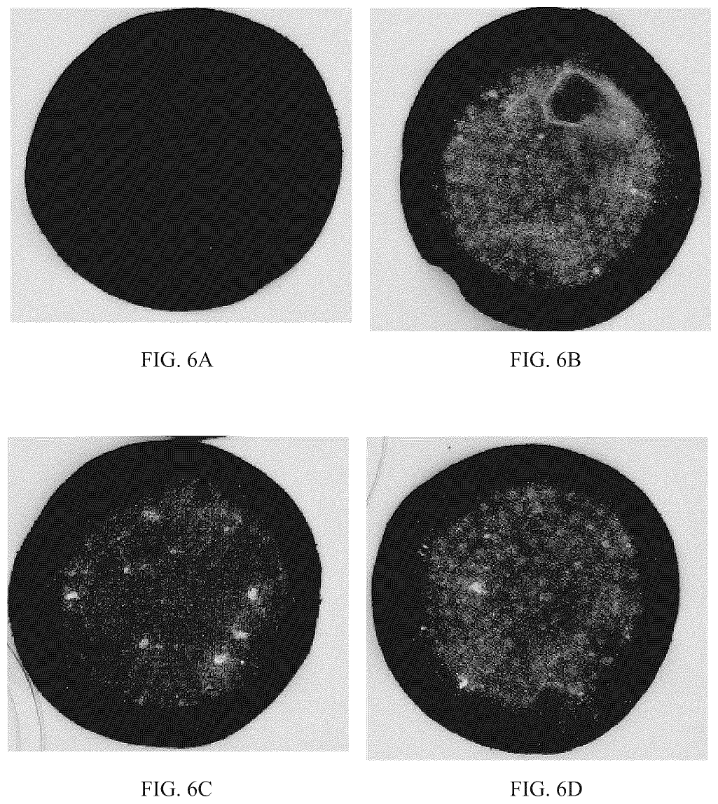

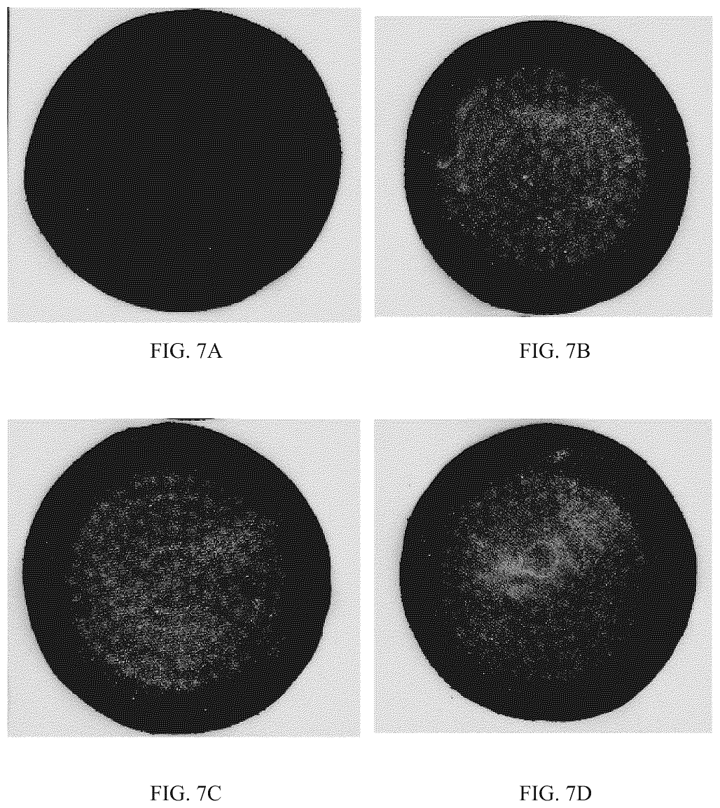

FIG. 4A, 5A, 6A, 7A are photographs of untreated/unstained samples of C70 black fabric, establishing the initial conditions of the fabric samples used. FIGS. 4B, 4C, and 4D are photographs of first, second, and third replicates, respectively, of a C70 black fabric after exposure to Composition 1 at 10° C. FIGS. 5B, 5C, and 5D are photographs of first, second, and third replicates, respectively, of a C70 black fabric after exposure to Composition 2 at 10° C. FIGS. 6B, 6C, and 6D are photographs of first, second, and third replicates, respectively, of a C70 black fabric after exposure to Composition 3 at 10° C. FIGS. 7B, 7C, and 7D are photographs of first, second, and third replicates, respectively, of a C70 black fabric after exposure to Composition 4 at 10° C. Table 3, summarizes the results of the measured level of residues per leg by weight (g) and by color (ΔE*ab) calculated as described above for the samples tested at 10° C.

TABLE 3
(10° C. results)

| | | | Delta E | |
|---|---|---|---|---|
| | Residue weight (g) | | (Average | |
| | (Average of 3 reps) | St Dev | of 3 reps) | St Dev |
| Composition 1 | 0.15 | 0.0058 | 25.12 | 2.59 |
| Composition 2 | 0.18 | 0.0153 | 34.64 | 1.48 |
| Composition 3 | 0.15 | 0.0416 | 25.37 | 3.98 |
| Composition 4 | 0.13 | 0.0416 | 21.85 | 0.22 |

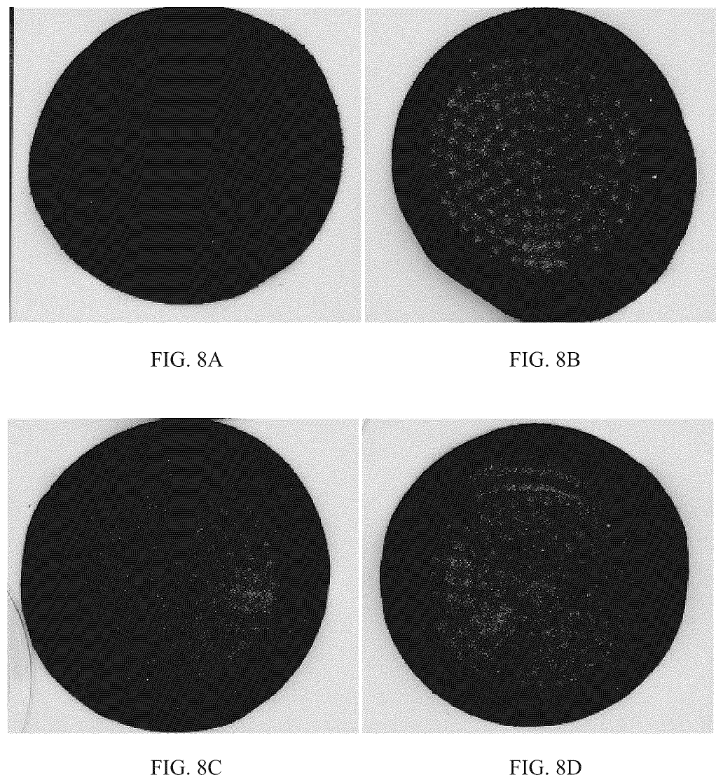

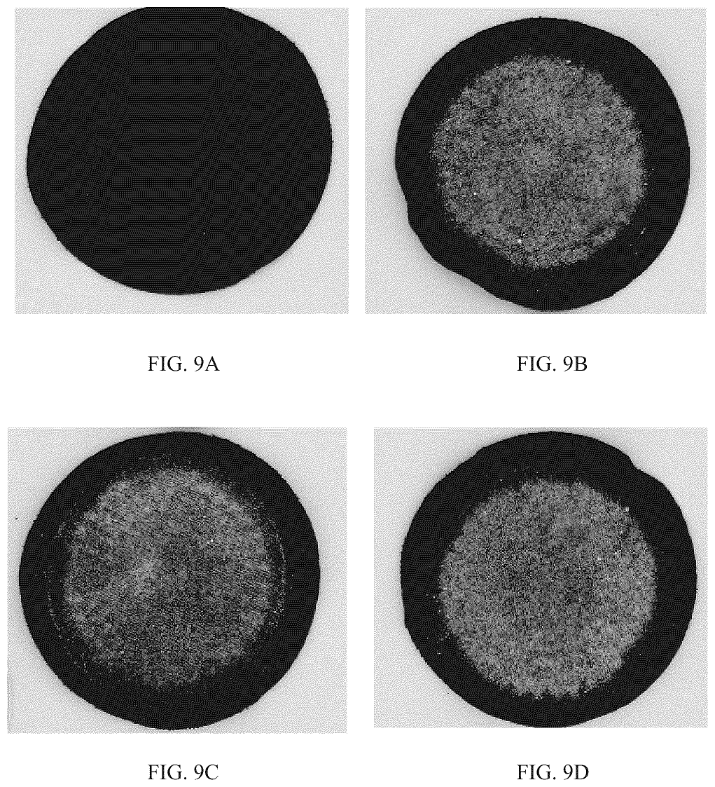

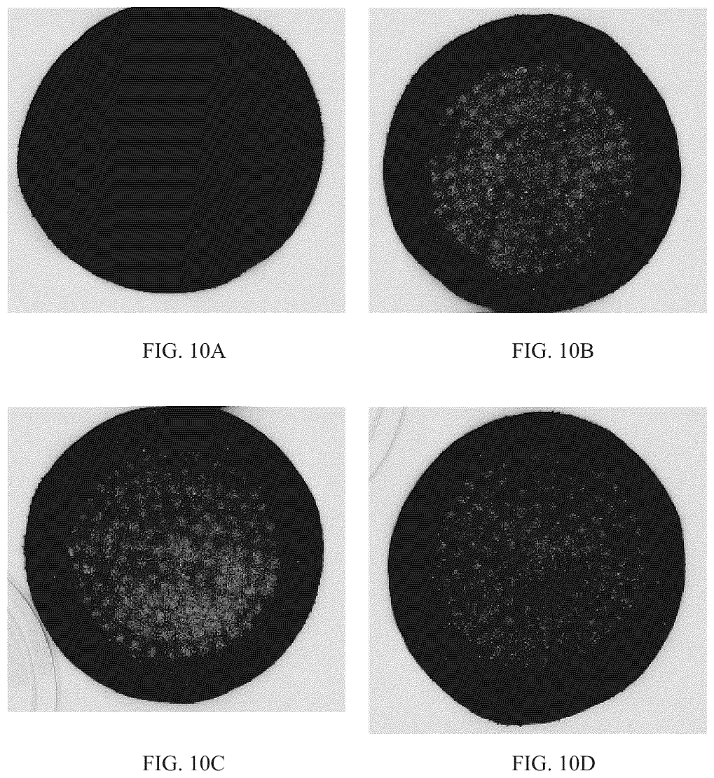

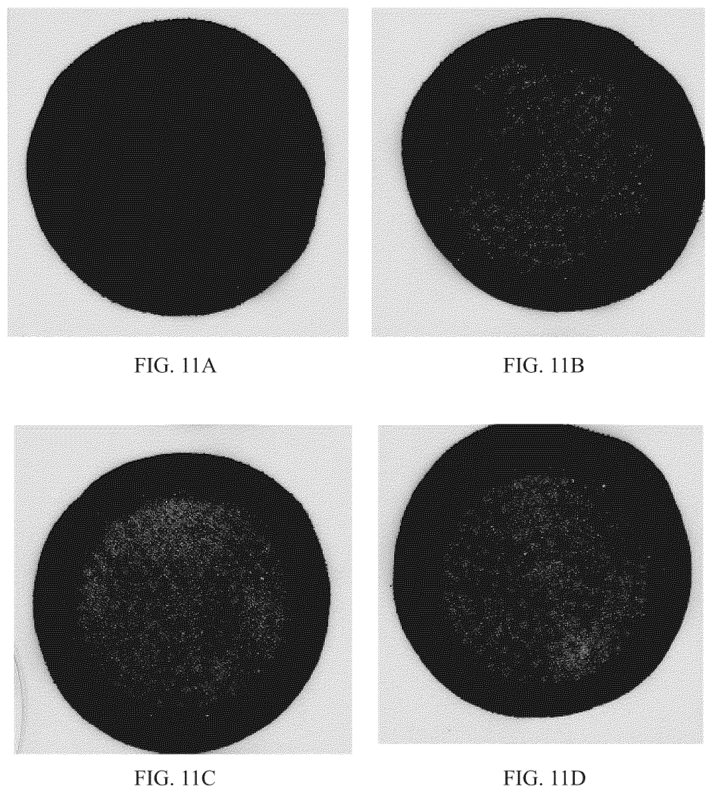

FIGS. 8A, 9A, 10A, and 11A are photographs of untreated/unstained samples of C70 black fabric, establishing the initial conditions of the fabric samples used. FIGS. 8B, 8C, and 8D are photographs of first, second, and third replicates, respectively, of a C70 black fabric after exposure to Composition 1 at 25° C. FIGS. 9B, 9C, and 9D are photographs of first, second, and third replicates, respectively, of a C70 black fabric after exposure to Composition 2 at 25° C. FIGS. 10B, 10C, and 10D are photographs of first, second, and third replicates, respectively, of a C70 black fabric after exposure to Composition 3 at 25° C. FIGS. 11B, 11C, and 11D are photographs of first, second, and third replicates, respectively, of a C70 black fabric after exposure to Composition 4 at 25° C. Table 4, summarizes the results of the measured level of residues per leg by weight (g) and by color (ΔE*ab) calculated as described above for the samples tested at 25° C.

TABLE 4
(10° C. results)

| | | | Delta E | |
|---|---|---|---|---|
| | Residue weight (g) | | (Average | |
| | (Average of 3 reps) | St Dev | of 3 reps) | St Dev |
| Composition 1 | 0.08 | 0.0153 | 14.53 | 2.19 |
| Composition 2 | 0.14 | 0.0058 | 33.50 | 1.69 |
| Composition 3 | 0.09 | 0.0153 | 20.23 | 3.32 |
| Composition 4 | 0.07 | 0.0058 | 16.58 | 2.71 |

The examples demonstrate the efficacy of fluidized bed layered granulates within a laundry detergent powder/web compositions to deliver less residues when tested at equal weight (composition 3) vs Drum batch process to give ‘mixed’ granulate (composition 2) and when tested at equal active enzyme (composition 4) vs Drum batch process to give ‘mixed’ granulate (composition 2).

### Example 3

A purpose of this example is to demonstrate residues left on black cotton and polyester fabrics by a variety of insoluble fillers (non-active components) having various particle sizes. The insoluble fillers included a zeolite having a dry particle size of 4 μm, precipitated calcium carbonate having a dry particle size of 7 μm, magnesium carbonate (MgCO₃) having a dry particle size of 15 μm, microcrystalline cellulose having a dry particle size of 20 μm, and microcrystalline cellulose having a dry particle size of 50 μm. 0.04 g of each filler per 800 mls 6 gpg water was used in each test. The solution was filtered through the fabric using a vacuum pump, 3-piece, 9 cm diameter Büchner funnel, and a PYREX® flask with a side arm. Three 20 replicates were completed for each material.

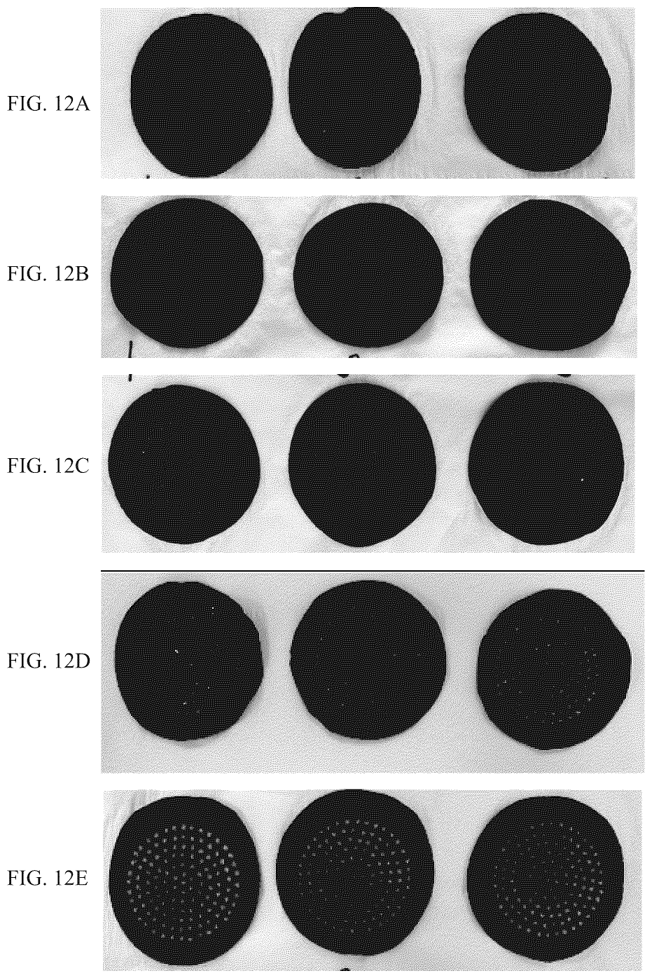

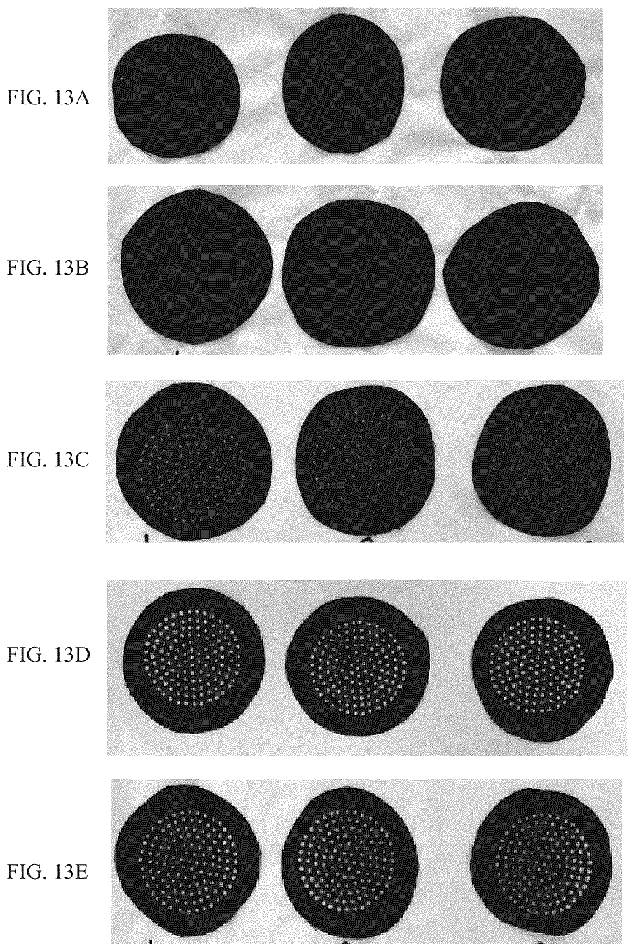

FIG. 12A and FIG. 13A each show photographs of three replicates of a technical black cotton fabric and a consumer black polyester fabric, respectively, after exposure to a zeolite having a dry particle size of 4 μm.

FIG. 12B and FIG. 13B each show photographs of three replicates of a technical black cotton fabric and a consumer black polyester fabric, respectively, after exposure to precipitated calcium carbonate having a dry particle size of 7 μm.

FIG. 12C and FIG. 13C each show photographs of three replicates of a technical black cotton fabric and a consumer black polyester fabric, respectively, after exposure to magnesium carbonate (MgCO₃) having a dry particle size of 15 μm.

FIG. 12D and FIG. 13D each show photographs of three replicates of a technical black cotton fabric and a consumer black polyester fabric, respectively, after exposure to microcrystalline cellulose having a dry particle size of 20 μm.

FIG. 12E and FIG. 13E each show photographs of three replicates of a technical black cotton fabric and a consumer black polyester fabric, respectively, after exposure to microcrystalline cellulose having a dry particle size of 50 μm.

Based on visual inspection of these figures, the polyester fabric exhibits more residues than the cotton technical test fabric. Suggesting its pore size is smaller for the entrapment of insoluble particles. Insoluble particles of 4 μm or less are proven to leave no visible residues on both cotton and polyester fabrics. Polyester shows visible residues for particle sizes greater than about 7 μm. Cotton shows visible residues for particle sizes greater than about 20 μm.

### Example 4

A purpose of this example is to demonstrate residues left on black cotton and polyester fabrics by a variety of granulate formulations as shown below. Four powder detergent compositions (Compositions 1 to 4) were made and tested as detailed herein below.

### Test Method

### I. Preparation of Test Compositions

Tests were carried out using the following detergent compositions: Material additions shown at active material level in finished product (FP).

TABLE 5

| | Enzyme | | | | | | | | |
|---|---|---|---|---|---|---|---|---|---|
| | activity | 1 | wt % or | 2 | wt % or | 3 | wt % or | 4 | wt % or |
| Ingredient | mg/g | (g/L) | g/100 g | (g/L) | g/100 g | (g/L) | g/100 g | (g/L) | g/100 g |
| Polyvinyl | | 0.1500 | 20.00 | 0.1500 | 17.10 | 0.1500 | 17.10 | 0.1500 | 19.33 |
| Alcohol (85,000 | | | | | | | | | |
| Molecular Weight) | | | | | | | | | |
| Polyvinyl | | 0.0750 | 10.00 | 0.0750 | 8.55 | 0.0750 | 8.55 | 0.0750 | 9.66 |
| Alcohol (25,000 | | | | | | | | | |
| Molecular Weight) | | | | | | | | | |
| Glycerin | | 0.0525 | 7.00 | 0.0525 | 5.98 | 0.0525 | 5.98 | 0.0525 | 6.76 |
| AE1S | | 0.1727 | 23.03 | 0.1727 | 19.69 | 0.1727 | 19.69 | 0.1727 | 22.26 |
| AE3S | | 0.0105 | 1.40 | 0.0105 | 1.20 | 0.0105 | 1.20 | 0.0105 | 1.35 |
| Amine Oxide | | 0.0502 | 6.69 | 0.0502 | 5.72 | 0.0502 | 5.72 | 0.0502 | 6.47 |
| Soap powder | | 0.0150 | 2.00 | 0.0150 | 1.71 | 0.0150 | 1.71 | 0.0150 | 1.93 |
| TAED | | 0.1622 | 21.62 | 0.1622 | 18.48 | 0.1622 | 18.48 | 0.1622 | 20.89 |
| AC-Base | | 0.0075 | 1.00 | 0.0075 | 0.85 | 0.0075 | 0.85 | 0.0075 | 0.97 |
| Protease | 33.17 | 0.0000 | 0.00 | 0.0911 | 10.39 | 0.0000 | 0.00 | 0.0000 | 0.00 |
| (production | | | | | | | | | |
| route 1) * | | | | | | | | | |
| Amylase | 14.95 | 0.0000 | 0.00 | 0.0361 | 4.12 | 0.0000 | 0.00 | 0.0000 | 0.00 |
| (production | | | | | | | | | |
| route 1) * | | | | | | | | | |
| Protease | 156.8 | 0.0000 | 0.00 | 0.0000 | 0.00 | 0.0911 | 10.39 | 0.0206 | 2.65 |
| (production | | | | | | | | | |
| route 2) ** | | | | | | | | | |
| Amylase | 48.1 | 0.0000 | 0.00 | 0.0000 | 0.00 | 0.0361 | 4.12 | 0.0055 | 0.71 |
| (production | | | | | | | | | |
| route 2) ** | | | | | | | | | |
| Water | | 0.0450 | 6.00 | 0.0450 | 5.13 | 0.0450 | 5.13 | 0.0450 | 5.80 |
| Perfume 1 | | 0.0053 | 0.70 | 0.0053 | 0.60 | 0.0053 | 0.60 | 0.0053 | 0.68 |
| Perfume 2 | | 0.0042 | 0.56 | 0.0042 | 0.48 | 0.0042 | 0.48 | 0.0042 | 0.54 |
| Total weight | | 0.7500 | 100.00 | 0.8772 | 100.00 | 0.8772 | 100.00 | 0.7761 | 100.00 |

* Production route1: Drum batch process to give ‘mixed’ granulate
** Production route 2: Fluidized bed layered granulate

### II. Test Procedure

TABLE 6

| | | |
|---|---|---|
| Wash Equipment | Tergotometer @ | Copley |
| | 200 rpm | |
| Wash Volume | 1000 ml | |
| Water Hardness | Tap water | ~7 gpg hardness |
| Water Temperature | 10 & 25° C. | |
| Detergent addition | 0.75-0.88 g | |
| Black fabric | C70 | Empirical Manufacturing Company, |
| | | 7637 Production Drive, Cincinnati, |
| | | Ohio 45237, USA. |
| Black fabric filtration | Vacuum pump | General Laboratory (with trap) |
| | Buckner funnel | 3-piece, glass, 9 cm diameter |
| | Flask | 1 L + Pyrex with side-arm. |
| Image and colour of residue | Image analysis | VeriVide - Digieye system for textiles |

### Analysis of Residues on Fabric

Determination of enzyme granulate production route impact on fabric residues was completed using the following procedure. Three external replicates were completed for each test product. 1000 ml of tap water was measured into each tergotometer pot and cooled to 10 C or heated to 25° C. 0.75-0.88 g product was then added and a timer started. After 20 minutes of dissolution, the full wash solution was taken from each tergotometer pot and filtered through the black fabric. Using Vacuum pump, 3-piece 9 cam diameter buckner funnel and pyrex flask with a side arm.

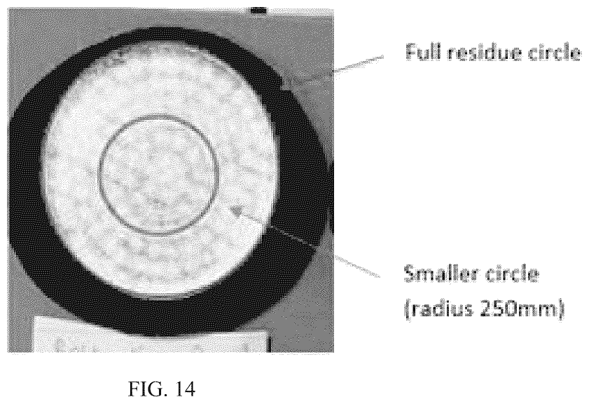

At the start of the test the black fabrics were weighed using a balance, so residue weight could be determined gravimetrically. Fabrics were left to dry at room temp over night before re-weighing and analyzing for L, a, b on the Digi eye. L, a, b measurements were taken over the full black fabric residue circle radius of 450 mm-see FIG. 14.

Results below show the measured level of residues per leg by weight (g) and by colour (Delta E) calculated as:
Delta E=SQRT (Delta L×Delta L+Delta a×Delta a+Delta b×Delta b)
Delta L=L washed−L initial
Delta a=a washed−a initial
Delta b=b washed−b initial

### 10° C. Results

TABLE 7

| | | | Delta E | |
|---|---|---|---|---|
| | Residue weight (g) | | (Average | |
| | (Average of 3 reps) | St Dev | of 3 reps) | St Dev |
| Composition 1 | 0.07 | 0.0028 | 3.90 | 0.1202 |
| Composition 2 | 0.09 | 0.0017 | 11.74 | 0.6510 |
| Composition 3 | 0.08 | 0.0027 | 3.21 | 0.7172 |
| Composition 4 | 0.07 | 0.0058 | 2.39 | 0.8142 |

### 25° C. Results

TABLE 8

| | | | Delta E | |
|---|---|---|---|---|
| | Residue weight (g) | | (Average | |
| | (Average of 3 reps) | St Dev | of 3 reps) | St Dev |
| Composition 1 | 0.07 | 0.0072 | 2.12 | 0.3092 |
| Composition 2 | 0.09 | 0.0032 | 9.70 | 0.8254 |
| Composition 3 | 0.08* | 0.0575 | 2.45 | 0.3995 |
| Composition 4 | 0.07 | 0.0053 | 1.59 | 0.4505 |

*Only 2 × reps of residue weight used for this data point. See image on page 5 highlighting blue product contamination. So this replicate was removed from weight calculations. Image still included to demonstrate similar visual residue profile from the replicate.

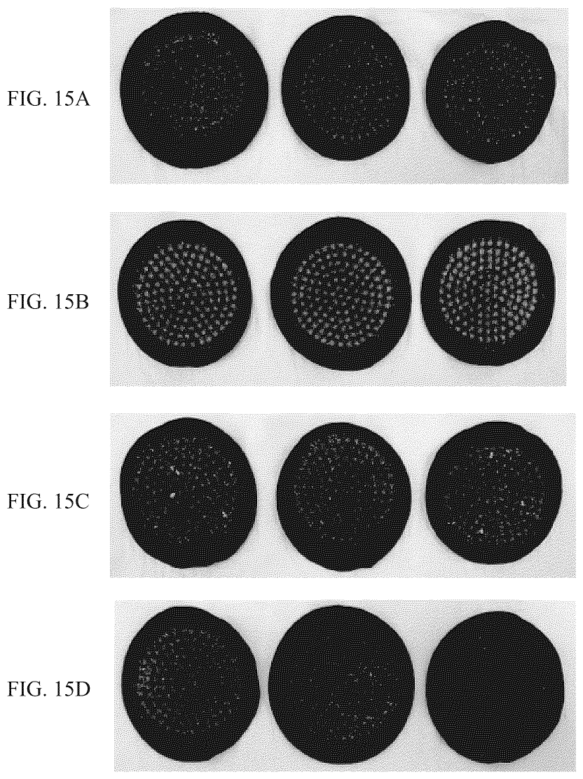

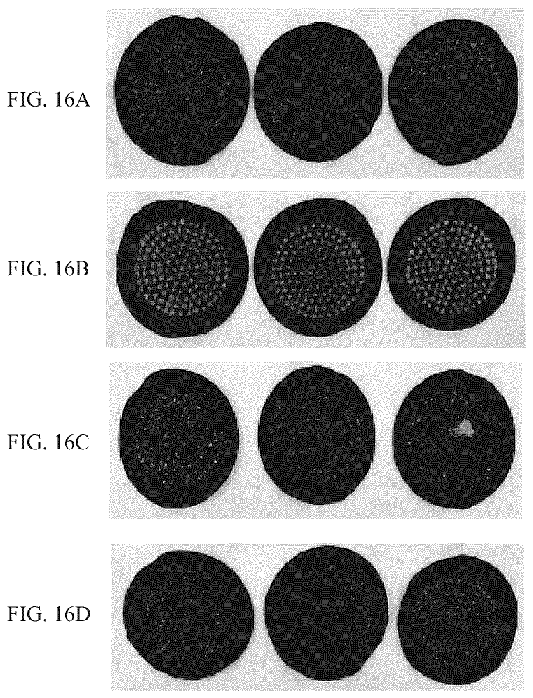

FIG. 15A and FIG. 16A each show photographs of three replicates of a technical black cotton fabric at 10 degrees C. and 25 degrees C., respectively, after exposure to Composition 1.

FIG. 15B and FIG. 16BA each show photographs of three replicates of a technical black cotton fabric at 10 degrees C. and 25 degrees C., respectively, after exposure to Composition 2.

FIG. 15C and FIG. 16C each show photographs of three replicates of a technical black cotton fabric at 10 degrees C. and 25 degrees C., respectively, after exposure to Composition 3. It is worth noting that the third picture demonstrates blue product contamination, impacting residue weight on this replicate.

FIG. 15D and FIG. 16D each show photographs of three replicates of a technical black cotton fabric at 10 degrees C. and 25 degrees C., respectively, after exposure to Composition 4.

The examples demonstrate the efficacy of fluidized bed layered granulates within a laundry detergent powder/web compositions to deliver less residues when tested at equal weight (composition 3) vs Drum batch process to give ‘mixed’ granulate (composition 2) and when tested at equal active enzyme (composition 4) vs Drum batch process to give ‘mixed’ granulate (composition 2).

### Further Definitions and Cross-References

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present disclosure have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A solid article comprising
a porous, dissolvable sheet; and
a particulate material comprising at least one particle that is partially water insoluble which comprises a first component and a second component, wherein the second component has a dry particle size of from about 0.01 μm to about 20 μm.

2. The solid article of claim 1, wherein:
the first component comprises a water-soluble active component; and
the second component is at least partially water-insoluble and is a non-active component.

3. The solid article of claim 1, wherein the dry particle size of the second component is measured before the second component is incorporated into the particulate material.

4. The solid article of claim 1, wherein, upon exposure to water at a temperature of 5° C. to 40° C. for a time of about 5 minutes to about 60 minutes, the at least one particle releases at least some of the first component and has a particle size of from about 0.01 μm to about 50 μm.

5. The solid article of claim 1, wherein the at least one particle does not comprise any second components that are at least partially water-insoluble and that have an average dry particle size greater than about 50 μm.

6. The solid article of claim 1, wherein the particulate material does not comprise any second components that are at least partially water-insoluble and that have an average dry particle size greater than about 50 μm.

7. The solid article of claim 1, wherein the unit dose article does not comprise any second components that are at least partially water-insoluble and that have an average dry particle size greater than about 50 μm.

8. The solid article of claim 1, wherein the at least one particle comprises from greater than 0% to about 70% by weight of the second component, where the second component comprises a non-active component, based on the total weight of the at least one particle.

9. The solid article of claim 1, wherein the at least one particle comprises from about 30%, preferably about 90% to about 100% by weight of the first component, where the first component comprises an active component, based on the total weight of the at least one particle.

10. The solid article of claim 1, wherein the particulate material comprises from about 60% to about 100% by weight based on the total weight of the solid article of a total amount of all second component present in the solid article.

11. The solid article of claim 1, wherein the particulate material comprises all of the second component, where the second component comprises a non-active component, present in the solid article.

12. The solid article of claim 1, wherein the solid article comprises a plurality of layers, and wherein the particulate material is dispersed between the plurality of layers.

13. The solid article of claim 1, wherein the second component has:
a dry particle size of from 1 μm to about 10 μm;
a swelling index of less than 2; and
a swelling-index-adjusted particle size of from about 0.01 μm to about 50 μm.

14. The solid article of claim 1, wherein the second component has a solubility in water of about 0 g/mL to about 10 g/mL at about 25 degrees C.

15. The solid article of claim 1, wherein the second component comprises a crystalline material and at least one of a filler, a carrier, a structurant, a builder, or a combination thereof.

16. The solid article of claim 1, wherein the first component comprises at least one enzyme.

17. The solid article of claim 1, further comprising:
a linear alkylbenzene sulfonate, alkylethoxylated sulfate, or a combination thereof; and
at least one of an inorganic dissolution aid, a rheology modifier, or a combination thereof.

18. The solid article of claim 1, further comprising linear alkylbenzene sulfonate and alkylethoxylated sulfate, and having a ratio of linear alkylbenzene sulfonate to alkylethoxylated sulfate of greater than 1.

19. The solid article of claim 1, further comprising a perfume microcapsule, a hueing agent, a bleaching agent, an enzyme, an aversive agent, a nonionic surfactant, or a combination thereof.

20. The solid article of claim 1, further comprising a printed area on an outer surface thereof.
